(19) United States
(12) Patent Application Publication
(10) Pub. No.: US 2013/0099083 A1
(43) Pub. Date: Apr. 25, 2013

(54) RESILIENT CEILING SUPPORT SYSTEM AND APPARATUS

(71) Applicants: Jean-Guy GAGNE, Etobicoke (CA); James W. Rogers, Toronto (CA)

(72) Inventors: Jean-Guy GAGNE, Etobicoke (CA); James W. Rogers, Toronto (CA)

(73) Assignee: Brainwave Research Corporation, Woodbridge (CA)

(21) Appl. No.: 13/656,144

(22) Filed: Oct. 19, 2012

Related U.S. Application Data
(63) Continuation-in-part of application No. 13/563,380, filed on Jul. 31, 2012.
(60) Provisional application No. 61/550,080, filed on Oct. 21, 2011.

(51) Int. Cl. F16M 13/02

(52) U.S. Cl. 248/327; 248/317

(57) ABSTRACT

A ceiling fixture support arm includes a rotational mechanism for interfacing the arm with ceiling support system structure. An extended member of the support arm and a member perpendicular thereto may include a rotational mechanism integral thereto as a hinged portion, or tab, thereof. One or more channels of the ceiling support structure may contain a plurality of flexible sections spaced at intervals along the length of two upper flanges that are separated by a channel width. Each section comprises a cantilevered tab formed in the flange material.

This is a continuation-in-part of application Ser. No. 13/563,380, filed Jul. 31, 2012 on behalf of inventors Jean-Guy Gagne and James Rogers. The benefit of provisional application Ser. No. 61/550,080, filed Oct. 21, 2011 on behalf of Jean-Guy Gagne and James Rogers, is claimed under 35 U.S.C. 119(e).

### BACKGROUND

This disclosure is related to installation of ceiling fixtures that are to be recessed above ceiling substrates, such as, for example, “can” light and “pot” light fixtures. Installation of such fixtures has traditionally involved a cumbersome procedure. A fixture must be physically held while aligning it in position and attaching it to the ceiling structure. Adjustment of fixture position without adequate support structure impedes maneuverability. Requirements for horizontal placement of the fixture as well as its depth dimension need to be considered. Once a fixture is nailed to a metal stud or joist, flexibility to meet alignment requirements is lost. Although fixtures may include mounting arms, there has not been an easy way to fasten the arms to the ceiling.

A need exists for the ability to determine spacing of a fixture and to maneuver the fixture until satisfied with its layout before securing it in position. A mechanism for containing the fixture while such adjustment is undertaken would be desirable. Such a mechanism should be capable of easy permanent attachment, both to the fixture and the ceiling structure.

Additional needs for improvement exist for simplifying depth adjustments. Installation resiliency should be considered to avoid vibration of the ceiling substrate and to counteract joist height irregularity.

### SUMMARY OF DISCLOSURE

The needs described above are fulfilled, at least in part, by a ceiling fixture support arm that includes a rotational mechanism for interfacing the arm with ceiling support system structure. The rotational mechanism is integral with the fixture support arm. A distal end of a member of the support arm that extends from the ceiling fixture is joined to a generally perpendicular member. Either or both of the extended member and perpendicular member may include a rotational mechanism as a hinged portion, or tab, thereof. The support arm may be made of sheet metal, plastic, or other material.

A fold line in the support arm material defines an axis about which the tab can rotate. The fold line may be formed by weakening an area in the support arm material or by creating spaces therein. An aperture proximate the fold line permits activation of rotation of the tab. A hinged portion in the extended support arm member can be rotated beneath a ceiling channel to lock the support arm to the channel on which it is placed. A flange on the support arm contains a surface for sliding the support arm on a channel for proper positioning prior to locking the support arm to the channel. The support arm can be secured to the channel by attaching thereto an overlapping portion of the support arm perpendicular member by a screw or like means.

A hinged portion in the perpendicular member can be rotated to adjust a height dimension of the support arm relative to the ceiling support system to accommodate use with ceiling channels or T-bars of different heights. The tab of the extended member can be rotated to lock the support arm to the ceiling structure with the hinged portion tab of the perpendicular member appropriately positioned for the height of the ceiling structure. The rotational axes of the hinged portions of both support arm members may be orthogonal to each other, the axis of the perpendicular member being vertical and the axis of the extended member being horizontal.

One or more channels of the ceiling support structure, to which the support arm may interface, may contain a plurality of flexible sections spaced at intervals along the length of two upper flanges that are separated by a channel width. Each section comprises a cantilevered tab formed in the flange material. An end of the tab is integral with the flange material while the remainder of the tab is detached from the flange material. A mounting hole proximate the detachable end of the tab, is configured for mounting the flange to a ceiling joist. The tabs are spaced at intervals that correspond to distances between ceiling joints such that tab mounting holes are in coincidence with adjacent ceiling joists for mounting the flanges thereon.

The tabs exhibit a flexibility characteristic that permits separation of the mounted flanges from the joists. The distance between the integral end of the tab and the mounting hole can be selected to correspond to a selected degree of separation between the flange and the joist. Portions at the integral end of the tab can be curved or widened to prevent detachment of the tab from the flange. The channel may be comprised of sheet metal. As the metal channel is isolated from wood joists except at the mounting locations of the detached ends of the cantilevered portions, a degree of sound proofing is effected between adjacent building floor levels. The channel flexibility and resiliency facilitates level of ceiling panels that are affixed to the channels. The channels may be installed in perpendicular or parallel orientation with respect to the ceiling joists.

### BRIEF DESCRIPTION OF DRAWINGS

Various exemplary embodiments are illustrated by way of example, and not by way of limitation, in the figures of the accompanying drawings in which like reference numerals refer to similar elements and in which:

FIG. 1a is a perspective view of a preferred embodiment of a bracket fixed to two parallel ceiling joists supporting a fixture;

FIG. 1b is an elevation view of the bracket installation shown in FIG. 1a;

FIG. 1c is a bottom view of the bracket installation shown in FIG. 1b;

FIG. 1d is a perspective view of an alternative bracket installation;

FIG. 1e is a detail view of a portion of FIG. 1d;

FIG. 1f is an elevation view of the bracket installation shown in FIG. 1d;

FIG. 1g is a detail view of a portion of FIG. 1f;

FIG. 1h is a bottom view of the bracket installation shown in FIG. 1f;

FIG. 1i is a perspective view of the bracket shown in FIGS. 1a-1h;

FIG. 1j is a plan view of the bracket shown in FIG. 1i;

FIG. 1k is an elevation view of the bracket shown in FIG. 1j;

FIG. 2a is a perspective view of an alternative preferred embodiment of the bracket shown in FIG. 1i;

FIG. 2b is a plan view of the bracket shown in FIG. 2a;

FIG. 2c is an elevation view of the bracket shown in FIG. 2b;

FIG. 3a is a perspective view from below of a preferred embodiment of joist mounted rails supporting a plurality of fixtures;

FIG. 3b is an elevation view of the rail installation shown in FIG. 3a;

FIG. 3c is a detail view of a portion of FIG. 3b;

FIG. 3d is a bottom view of the rail installation shown in FIG. 3b;

FIG. 3e is a perspective view of the rail installation shown in FIGS. 3a-3d;

FIG. 3f is a side view of the rail installation shown in FIG. 3e;

FIG. 3g is a detail view of a portion of FIG. 3f;

FIG. 3h is a front elevation of the rail installation shown in FIG. 3e;

FIG. 3i is a detail view of a portion of FIG. 3h;

FIG. 3j is a bottom view of the rail shown in FIG. 3h;

FIG. 3k is a detail view of a portion of FIG. 3j;

FIG. 4a is a perspective view from below of a resilient channel installation;

FIG. 4b is a front elevation of the channel installation shown in FIG. 4a;

FIG. 4c is a side elevation of the channel installation shown in FIG. 4b;

FIG. 4d is a bottom view of the channel installation shown in FIG. 4b;

FIG. 4e is a detail view of a portion of FIG. 4c;

FIG. 4f is a perspective view from below of the channel shown in FIGS.

4a-4e;

FIG. 4g is a perspective view from above of the channel shown in FIGS. 4a-4e;

FIG. 4h is an end view of the channel shown in FIGS. 4f-4g;

FIG. 5a is a perspective view from below of another channel installation;

FIG. 5b is a side elevation of the channel installation shown in FIG. 5a;

FIG. 5c is a detail view of a left portion of FIG. 5b;

FIG. 5d is a detail view of a middle portion of FIG. 5c;

FIG. 5e is a perspective view from above of the channel shown in FIGS. 5a-5d;

FIG. 5f is an end view of the channel shown in FIG. 5e;

FIG. 5g is a perspective view from above of the hanger shown in FIGS. 5a-5d;

FIG. 5h is an end view of the hanger shown in FIG. 5g;

FIG. 6a is a perspective view from below of another channel installation;

FIG. 6b is a side elevation of the channel installation shown in FIG. 6a;

FIG. 6c is a detail view of a left portion of FIG. 6b;

FIG. 6d is a detail view of a middle portion of FIG. 6c;

FIG. 6e is a perspective view from below of the hanger shown in FIGS. 6a-6d;

FIG. 6f is an end view of the hanger shown in FIG. 6e;

FIG. 7a is a perspective view from below of another channel installation;

FIG. 7b is a front elevation of the channel installation shown in FIG. 7a;

FIG. 7c is a detail view of the portion of FIG. 7b;

FIG. 7d is a side elevation of the channel installation shown in FIG. 7a;

FIG. 7e is a detail view of a left portion of FIG. 7d;

FIG. 7f is a detail view of a middle portion of FIG. 7d;

FIG. 7g is a top view of the hanger shown in FIGS. 7a-7f;

FIG. 7h is a perspective view of the hanger shown in FIG. 7g;

FIG. 7i is a side view of the hanger shown in FIG. 7g;

FIG. 7j is a side view of the hanger shown in FIG. 7i;

FIG. 8a is a front elevation of another channel installation;

FIG. 8b is a detail view of a portion of FIG. 8a;

FIG. 8c is a side elevation of the channel installation shown in FIG. 8a;

FIG. 8d is a detail view of a left portion of FIG. 8c;

FIG. 8e is a detail view of a middle portion of FIG. 8c;

FIG. 8f is a top view of the hanger assembly shown in FIGS. 8a-8e;

FIG. 8g is a perspective view of the hanger assembly shown in FIG. 8f;

FIG. 8h is a side view of the hanger assembly shown in FIG. 8f;

FIG. 8i is a side view of the hanger assembly shown in FIG. 8h;

FIG. 8j is an exploded perspective view of the hanger assembly shown in FIGS. 8f-8i;

FIG. 8k is a bottom view of the exploded hanger assembly shown in FIG. 8j;

FIG. 9a is a top view of an alternative hanger assembly embodiment;

FIG. 9b is a perspective view of the hanger assembly shown in FIG. 9a;

FIG. 9c is a side view of the hanger assembly shown in FIG. 9a;

FIG. 9d is a side view of the hanger assembly shown in FIG. 9c;

FIG. 10a is a perspective partial view from below of a support channel with a barbed sprung retainer;

FIG. 10b is a detail view of a portion of FIG. 10a;

FIG. 10c is a side view of the installation shown in FIG. 10a;

FIG. 10d is a detail view of a portion of FIG. 10c;

FIG. 10e is a perspective view from below and behind of the installation shown in FIG. 10a;

FIG. 10f is a detail view of a portion of FIG. 10e;

FIG. 11a is a perspective view from above of a support arm with a ramped locking device on a channel;

FIG. 12a is a perspective view from above of a support arm with a U-shaped locking element;

FIG. 13a is a perspective view from above of a support arm with a rotating sheet metal locking element;

FIG. 14a is a perspective view of a pot light support arm having a twist lock;

FIG. 14b is a different perspective view of the pot light support arm shown in FIG. 14a;

FIG. 14c is an orthographic view of the pot light support arm;

FIG. 14d is side view of FIG. 14c;

FIG. 14e is a bottom view of the FIG. 14d;

FIG. 14f is a section view taken from FIG. 14d.

FIG. 14g is a detail view taken from FIG. 14a.

FIG. 15a is a perspective view of a pot light with support arm positioned on resilient channels.

FIG. 15b is a detail view taken from FIG. 15a;

FIG. 15c is an elevation view of FIG. 15a;

FIG. 15d is a detail view taken from FIG. 15c;

FIG. 15e is a perspective view of the installation shown in FIG. 15a in a locked state;

FIG. 15f is a detail view taken from FIG. 15e;

FIG. 15g is an elevation view of the installation shown in FIG. 15e;

FIG. 15h is a detail view taken from FIG. 15g;

FIG. 16a is a perspective view of the apparatus in FIGS. 15a-h, shown mounted on T-bar ceiling main elements;

FIG. 16b is a detail view taken from FIG. 16a, in an unlocked state;

FIG. 16c is an elevation view of FIG. 16b;

FIG. 16d is a detail view taken from FIG. 16a, in a locked state;

FIG. 16e is an elevation view of FIG. 16d;

FIG. 17a is a perspective view of an alternative embodiment;

FIG. 17b is a detail view taken from FIG. 17a, in an unlocked state;

FIG. 17c is an elevation view of FIG. 17b.

FIG. 17d is a detail view taken from FIG. 17a, in a locked state;

FIG. 17e is an elevation view of FIG. 17d;

FIG. 18a is a perspective view of a pot light assembly mounted on a resilient channel;

FIG. 18b is a side view of the assembly shown in FIG. 18a;

FIG. 18c is a detail view taken from the left side of FIG. 18b;

FIG. 18d is a detail view taken from the right side of FIG. 18b;

FIG. 18e is a section view taken from FIG. 18b;

FIG. 18f a detail view taken from FIG. 18e;

FIG. 19a is a perspective view of the resilient channel shown in FIGS. 18a-f;

FIG. 19b is a detail view taken from FIG. 19a;

FIG. 20a is a perspective view of the resilient channel of FIG. 19a shown in a deflected state;

FIG. 20b is a detail view taken from FIG. 20a;

FIG. 20c is a side view of the assembly shown in FIG. 20a;

FIG. 20d is a detail view taken from FIG. 20c;

FIG. 21a is a perspective view of an assembly mounted on resilient channels shown in FIGS. 19a-b;

FIG. 21b is a detail view taken from FIG. 21a;

FIG. 21c is a side view of FIG. 21a;

FIG. 21d is a detail view taken from FIG. 21c exemplifying a locked state;

FIG. 22a is perspective view of the installation shown in FIGS. 21a-d, mounted on T-bar main ceiling elements;

FIG. 22b is a detail view taken from FIG. 22a exemplifying a locked state;

FIG. 22c is a side view of FIG. 22a;

FIG. 22d is a detail view taken from FIG. 22c;

FIG. 23a is a perspective view of the installation shown in FIGS. 21a-d and FIGS. 22a-d, mounted on T-bar cross structural elements;

FIG. 23b is a detail view taken from FIG. 23a;

FIG. 23c is a side view of FIG. 23a; and

FIG. 23d is a detail view taken from FIG. 23c.

### DETAILED DISCLOSURE

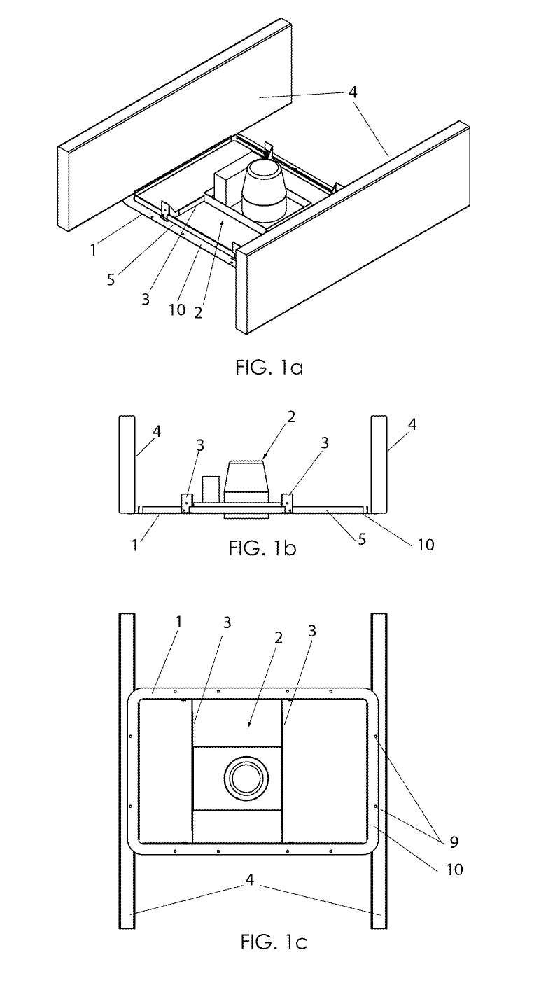

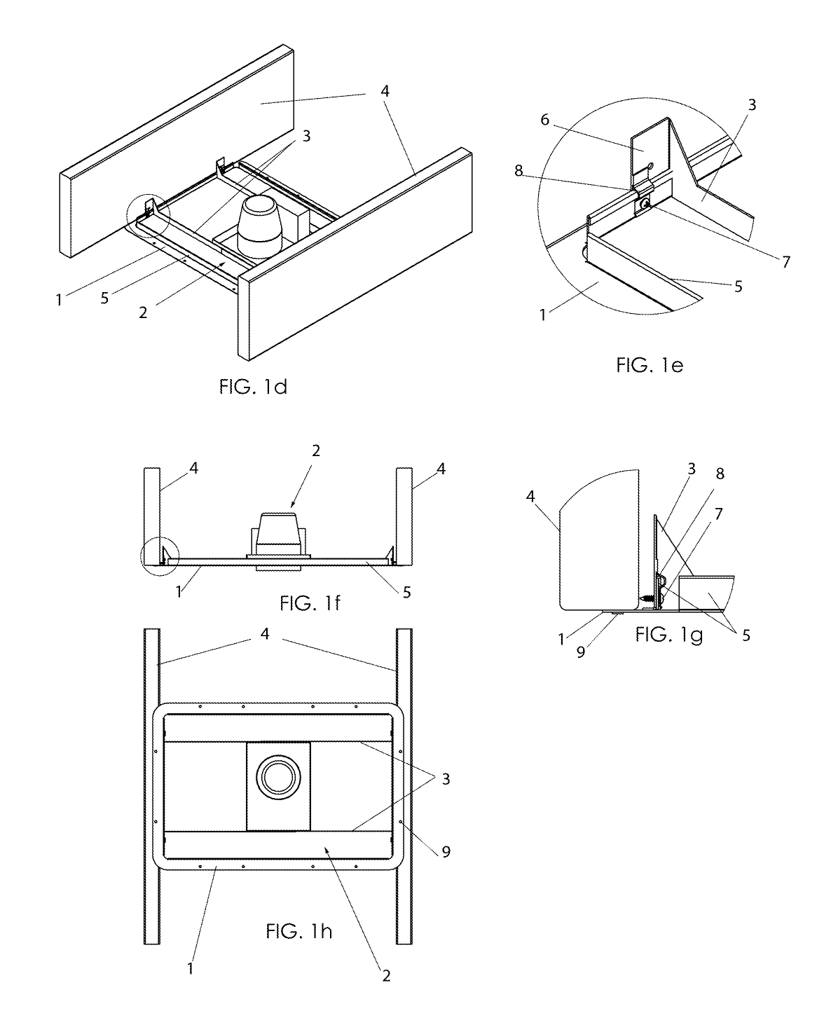

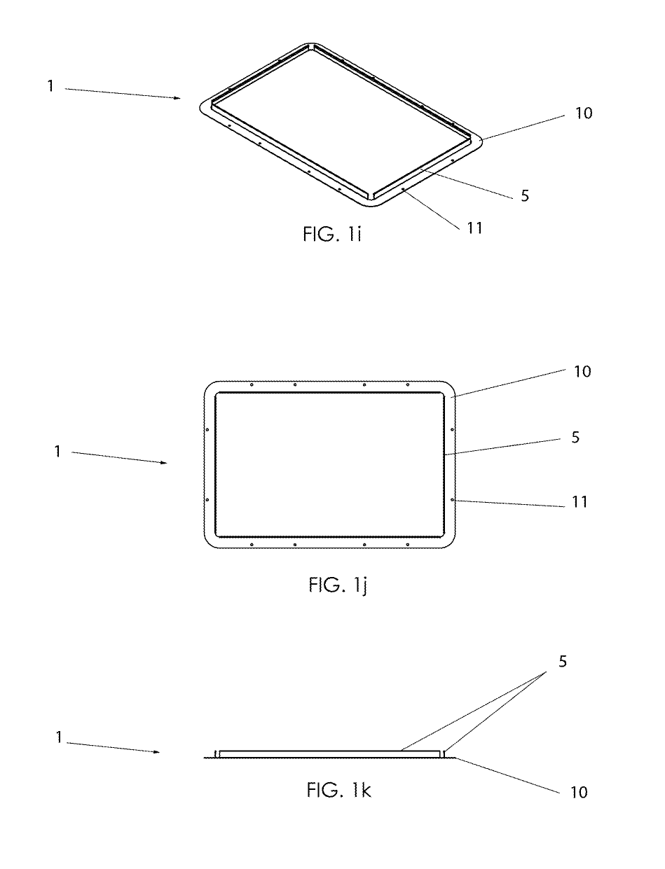

Referring to FIGS. 1a-1c, bracket 1 is fixed to two parallel ceiling joists 4 for supporting a fixture 2, exemplified by a pot light having support arms 3. Installation may occur during a rough-in stage of new construction, the base 10 of bracket mount to ceiling joists 4 with fasteners 9. The support arms 3 of pot light 2 are hung on the vertical flange elements 5 of bracket 1 that are parallel to the joists. Once supported by bracket 1, pot light 2 can be moved horizontally, in a direction parallel with the joists, within bracket 1 to its optimum position prior to being fixed in place with screws or other attachment devices. The bracket 1 may be fixed on joists 4 that are spaced, for example at twenty-four inch centers. The width of the bracket may be dimensioned to accommodate joists spaced differently, for example at sixteen inch centers with the position of the bracket rotated by ninety degrees.

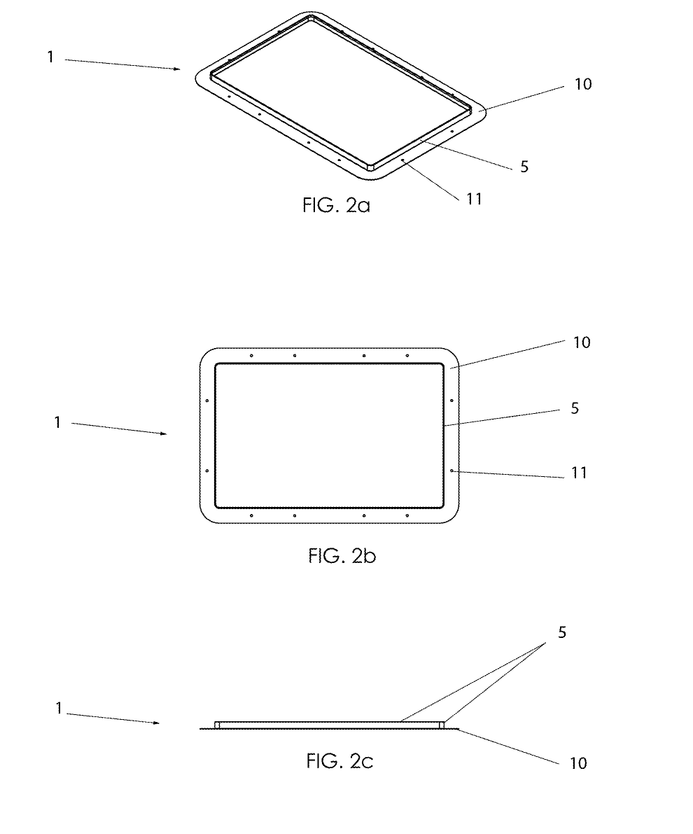

Horizontal base 10 and vertical flange element 5 and holes 11 for fasteners are shown in more detail in FIGS. 1i-k. In the illustrated structure, flange element 5 is discontinuous at the corners of the bracket frame for ease of construction if the bracket is formed of metal. However, the flange element 5 may be continuous about the entire periphery, as shown in FIGS. 2a-c if the bracket is injection molded plastic or the like.

As shown in FIGS. 1d-1h, the pot light support arms 3 may be hung on the flange elements 5 of bracket 1 that are perpendicular to the joists. With this orientation, pot light 2 can be moved in the perpendicular direction to adjust its position with respect to its distance from joist 4.

As shown in FIG. 1e, a sprung bent element 8 extends from flange 6 at the end of pot light arm 3. Flange 6 straddles vertical flange element 5 of bracket 1. Self-tapping fastener 7 is inserted through a hole in bent element 8 fixing pot light arm 3 to vertical flange element 5 of bracket 1.

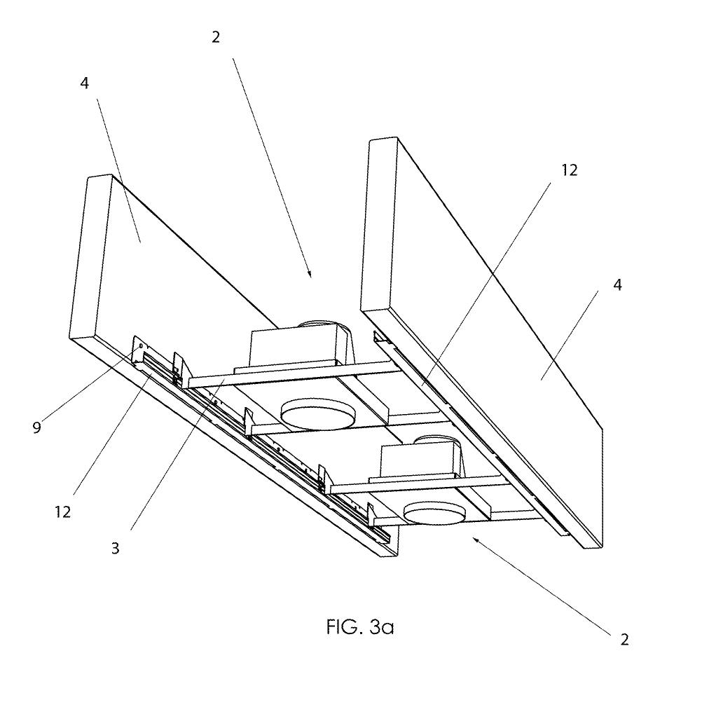

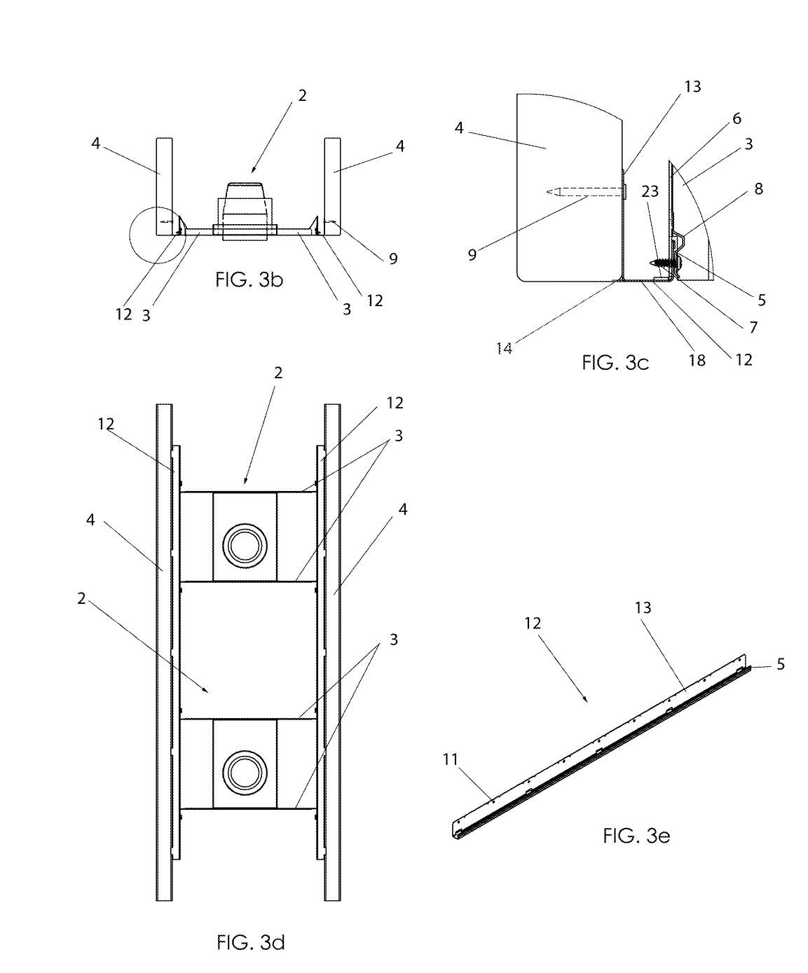

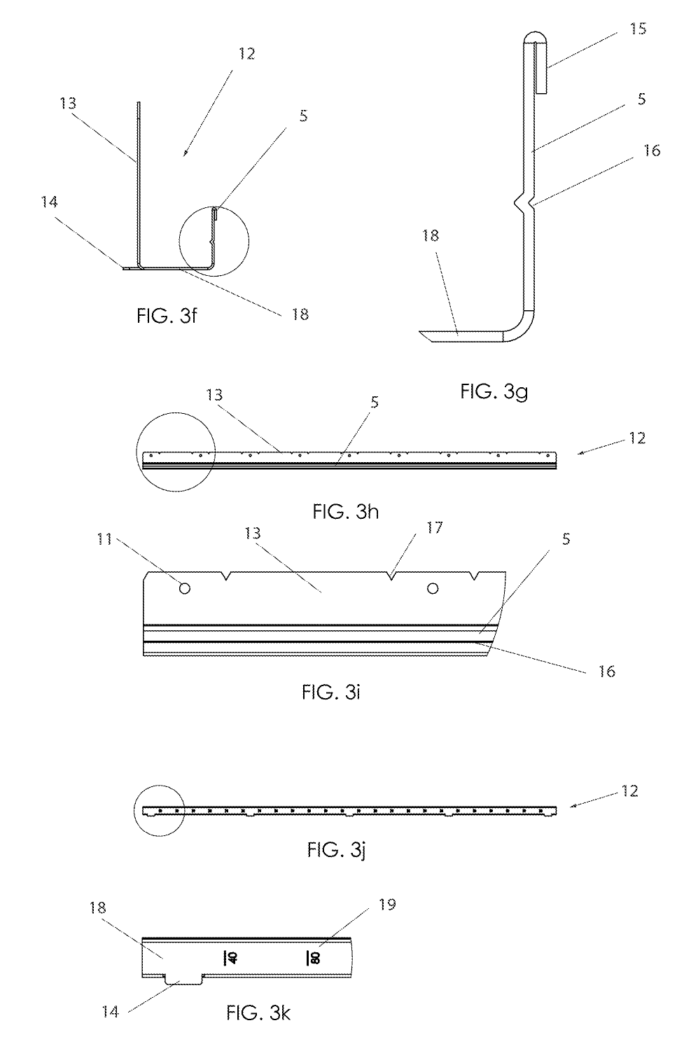

A plurality of fixtures may supported by rails mounted to joists, as illustrated in FIGS. 3a-3b and 3d. Rails 12 are mounted facing each other on adjacent joists 4 for supporting pots lights 2 via support arms 3. Rails 12 may be mounted with fasteners 9 through vertical mounting flange 13 during rough-in stage of new construction. Pot lights 2 are hung on rails 12 and can be slid to the optimum position before being fixed in place. Rails 12 may be butted end to end to create a longer support structure for electrical devices (not shown).

As illustrated in FIG. 3c, pot light support arm 3 includes a sprung bent element 8 extending from flange 6. Flange 6 straddles vertical flange element 5 of rail 12, which is fastened to joist 4 with fastener 9 through vertical mounting flange 13. The foot of the pot light arm 23 rests on the top surface of horizontal element 18 of rail 12, ensuring that the pot light 2 extends appropriately below joists 4 to be substantially flush with the underside of the drywall (not shown) fastened to the underside of the joists. Tabs 14 of rail 12 extending beneath the edge of joist 4 act as positioning elements during installation to ensure that rail 12 is located flush with the underside of joist 4.

Rail 12 is shown in more detail in FIGS. 3e and 3f. Mounting holes 11 are located on vertical mounting flange 13. The vertical flange element 5 extends from horizontal element 18 opposite the vertical mounting flange 13. Tab 14 is in line with horizontal element 18 beneath vertical mounting flange 13.

FIG. 3g is a detail view of horizontal element 18 with vertical element 5 extending therefrom. Vertical element 5 is capped with hem 15. Hem 15 removes the sharp exposed edge, provides additional strength, and provides temporary vertical retention to sprung bent element 8 shown in FIG. 3c. Linear recess 16 on vertical elements 5 facilitates initial penetration and threading of self-tapping fastener 7 shown in FIG. 3c. FIG. 3h shows rail 12 with vertical flange element 5 and vertical mounting flange 13. In FIG. 3i, vertical flange element 5 is shown with linear recess 16. Vertical mounting flange 13 is shown with mounting holes 11 and scores 17 to facilitate cutting with shears or the like at intervals on either side of mounting holes 11. Rail 12 with horizontal element 18 and tabs 14 are depicted in FIGS. 3j and 3k. Printed or debossed length markings 19 on the underside of horizontal element 18, coinciding with score marks 17, illustrated in FIG. 3i, facilitate cutting to length without need for measurement with a tape measure or the like. These dimension gradients can also be used to facilitate pot light spacing.

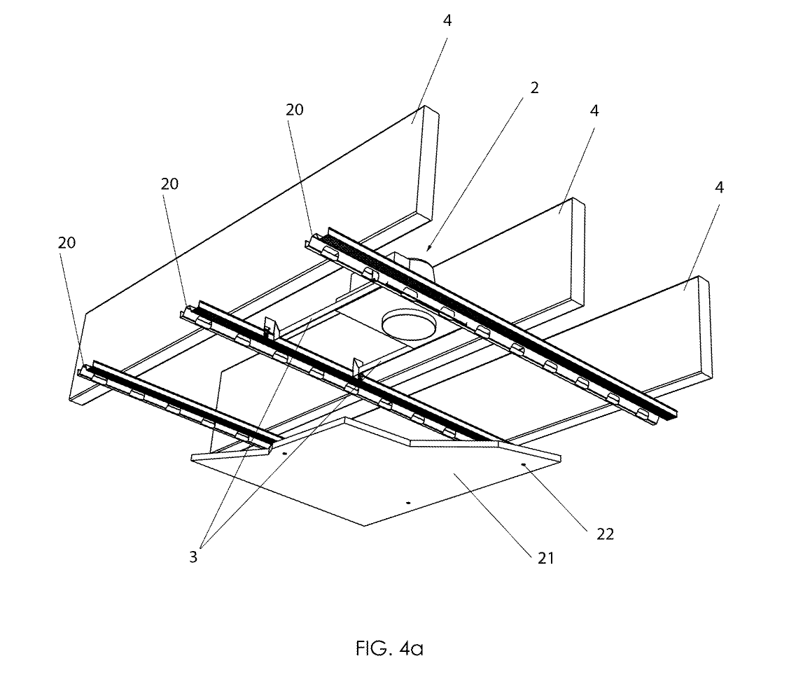

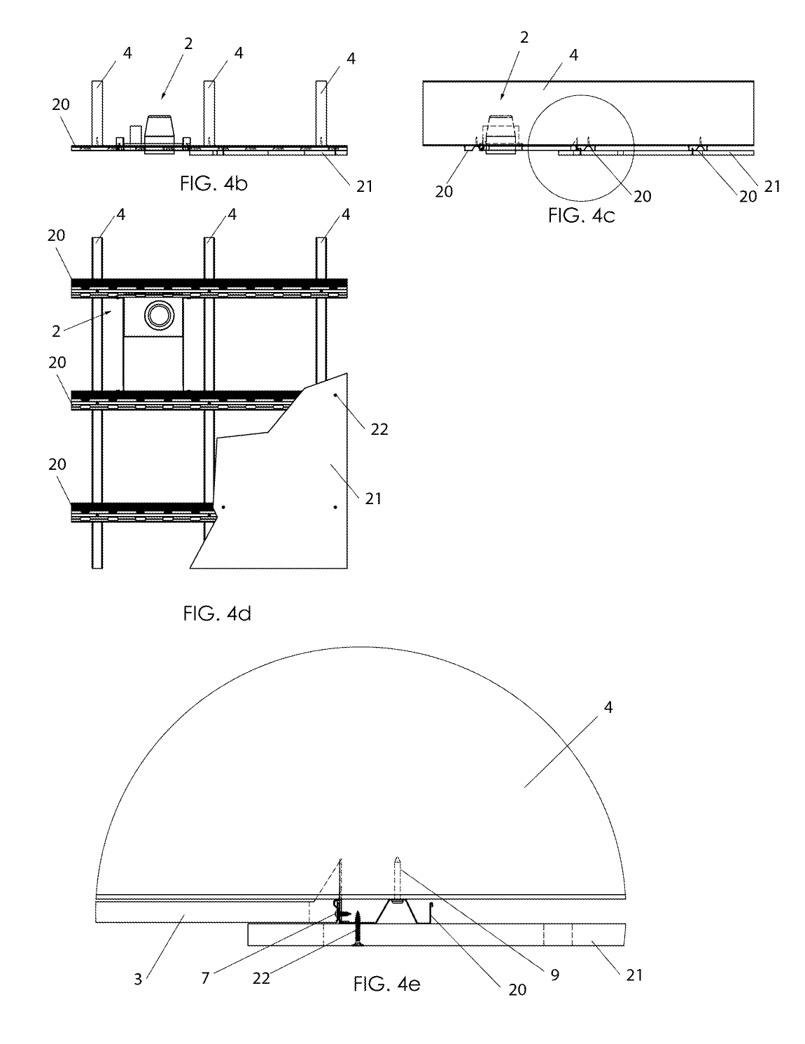

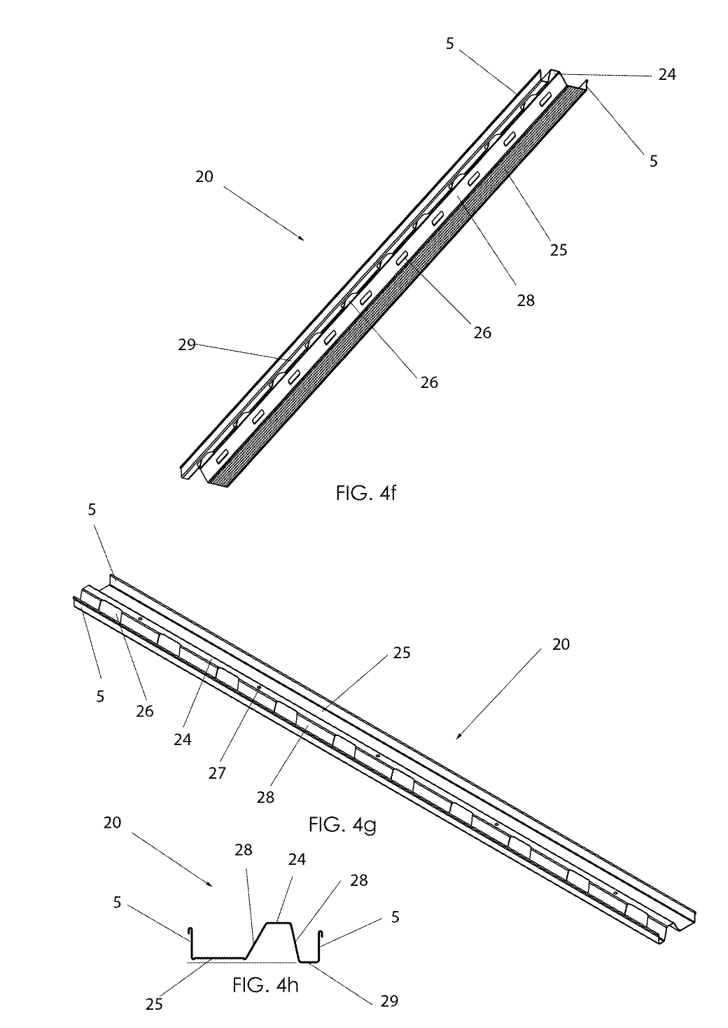

Referring to the resilient channel installation illustrated in FIGS. 4a-4d, ceiling joists 4 support resilient channels 20, which in turn support pot light 2 via support arms 3 and drywall 21 via fasteners 22. Resilient channels 20 provide for a more flat installation of drywall 21 by flexing to account for out variations in distance from the undersides of joists 4. Resilient channels 20 also dissipate sound wave transmission between floors. By nature of the flexibility of resilient channel 20, the drywall is structurally decoupled from joists 4, thereby transmitting substantially less vibration and sound energy. Joist 4 supports resilient channel 20 with fastener 9, as illustrated in FIG. 4e. One pot light support arm 3 is supported by resilient channel 20 and fixed in place with fastener 7. Drywall 21 is screwed to resilient channel 20 with fastener 22.

Resilient channel 20 may include angled elements 28 and cut away holes 26 to facilitate flexion, as illustrated in FIG. 4f. Vertical elements 5 extend from either side of resilient channel 20, allowing pot light support on both sides. Horizontal drywall mounting surface 25 comprises debossed dimples that facilitate initial penetration and threading of self tapping fastener 22, as shown in FIG. 4f. Channel mounting holes 27 are located on the upper horizontal mounting surface 24. Vertical elements 5 and angled elements 28 are illustrated in the sectional view of FIG. 4h. Narrow horizontal pot light support element 29 extends below the drywall mounting surface 25 so that after installation of the drywall narrow horizontal pot light support element 29 is forced upwards and is flush with drywall mounting surface 25, ensuring that the pot light is installed parallel to the drywall.

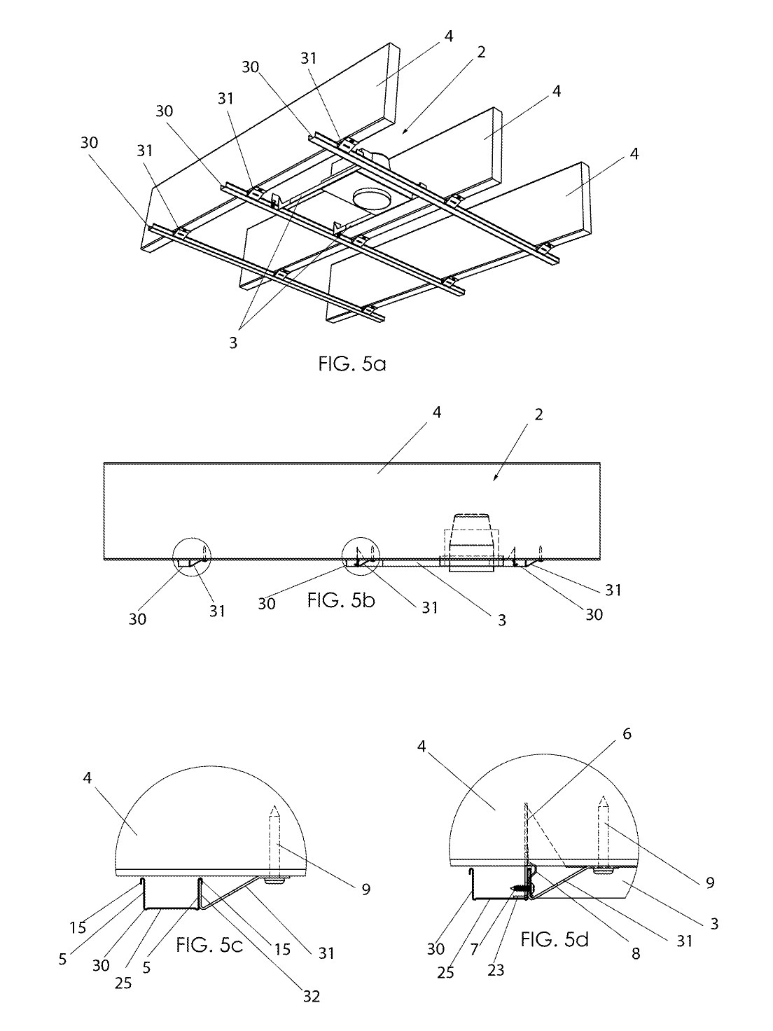

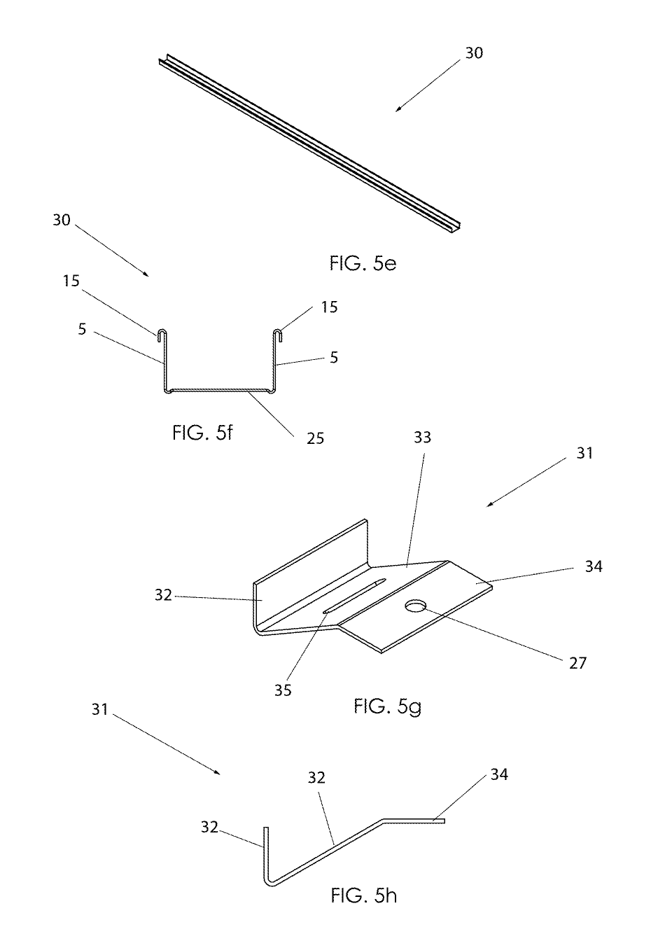

An alternative channel assembly is illustrated in FIGS. 5a-d. Channel 30 has a U shaped cross-section with hems 15 at the top of vertical elements 5. Hangers 31 are screwed into joists 4 with fasteners 9. Vertical element 32 of hanger 31 hooks under hem 15 and supports channel 30. Drywall (not shown), or other ceiling substrate, may be screwed to the underside of channel 30 through substrate mounting surface 25. Pot light 2, via support arms 3, fits over channel vertical element 5. Pot light sprung bent element 8 temporary retains the position until fastener 7 is screwed through the sprung bent element 8 and the vertical element 5 of channel 30 to retain it permanently. Pot light support arm foot 23 rests on the inside bottom of channel 30. Hanger 31, due to its geometry, allows the channel 30 to flex down and provide a more flat drywall installation and reduce the amount of sound transmission that passes through the structure. Vertical elements 5, hems 15 and drywall support surface 25 are depicted in more detail in FIGS. 5e-5f. FIGS. 5g-5h depict hanger 31 with mounting surface 34 and mounting hole 27. Vertical element 32, along with angled element 33 and cut away area 35, facilitate flexion.

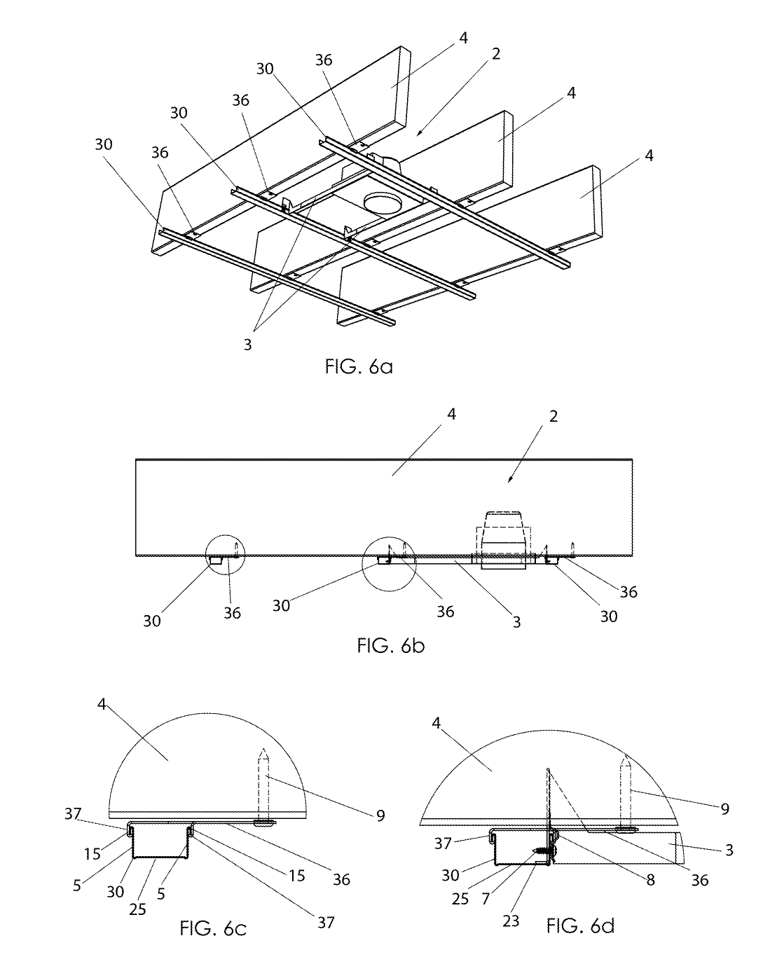

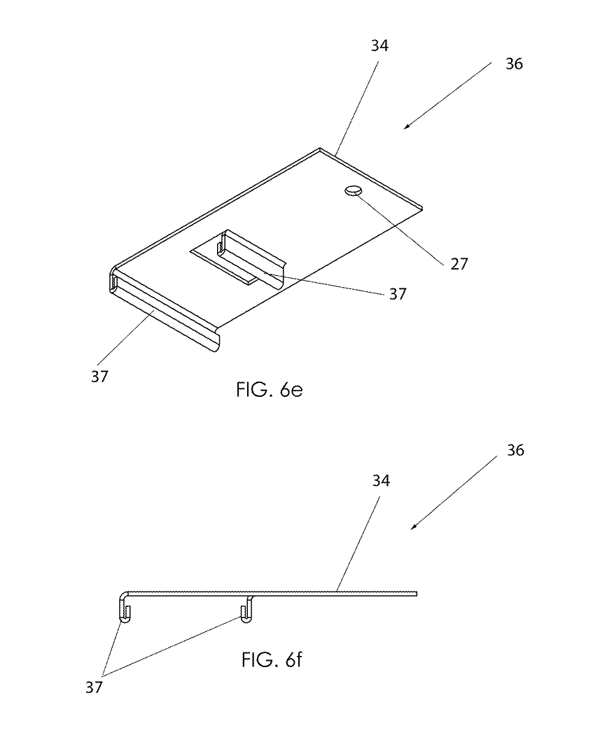

Another alternative installation assembly is illustrated in FIGS. 6a-6d. Resilient hangers 36 are screwed into joists 4 with fasteners 9. Hemmed retainers 37 of hanger 36, hooked under hems 15, support channel 30. Drywall (not shown), or other ceiling substrate, screws to the underside of channel 30 through drywall mounting surface 25. Pot light 2, via support arms 3, fits over channel vertical element 5. Pot light sprung bent element 8 temporary retains position until fastener 7 is screwed through the sprung bent element 8 and the vertical element 5 of channel 30 to retain it permanently. Pot light support arm foot 23 rests on the inside bottom of channel 30. Hanger 36, due to its geometry, allows channel 30 to flex down and provide a more flat drywall installation and reduce the amount of sound transmission that passes through the structure. Channel 30 can be slid into hanger 36 from the end. Alternatively, it can be snapped into the hemmed retainers 37 by flexing the vertical elements 5 of channel 30 toward each other, pushing it beyond the hemmed retainer 37, and releasing the flexed vertical elements 5, allowing them to drop into hemmed retainers 37. FIGS. 6e-6f depict hanger 36 with mounting surface 34, mounting hole 27, and hemmed retainers 37. The distance between the hemmed retainers 37 and the mounting hole 27 allows the hanger to flex when the channel is loaded with drywall.

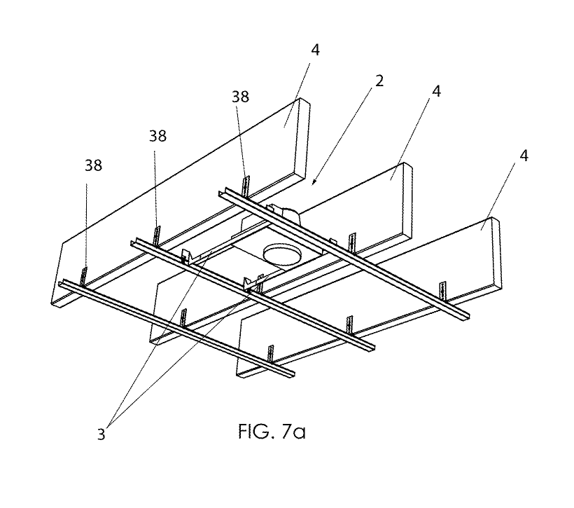

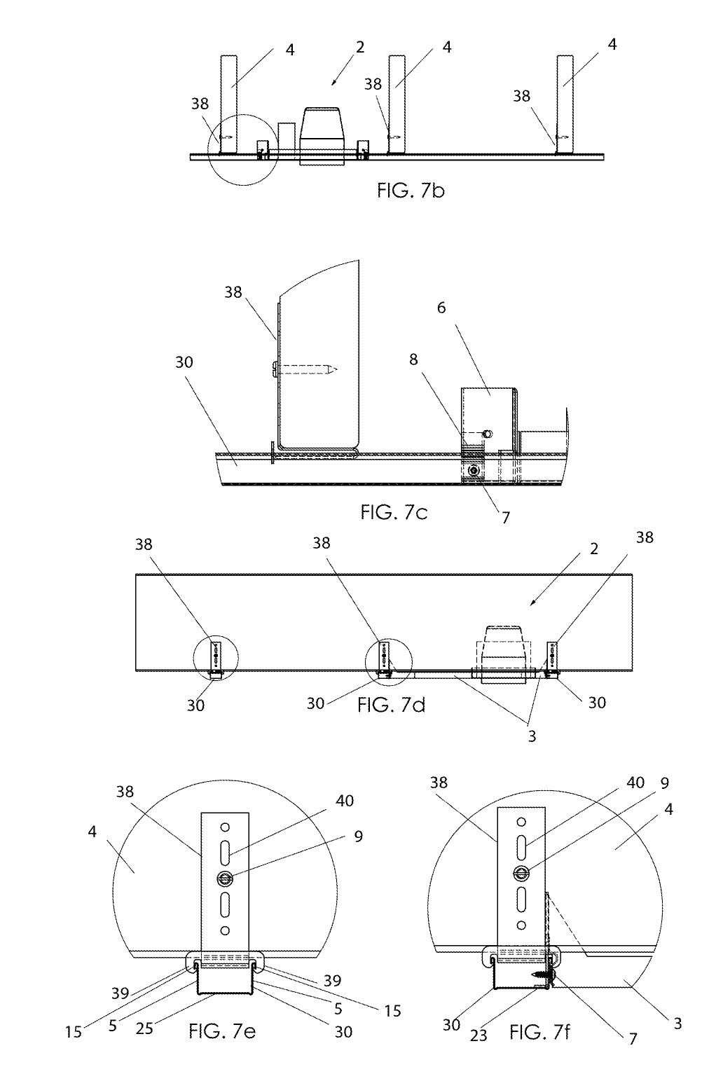

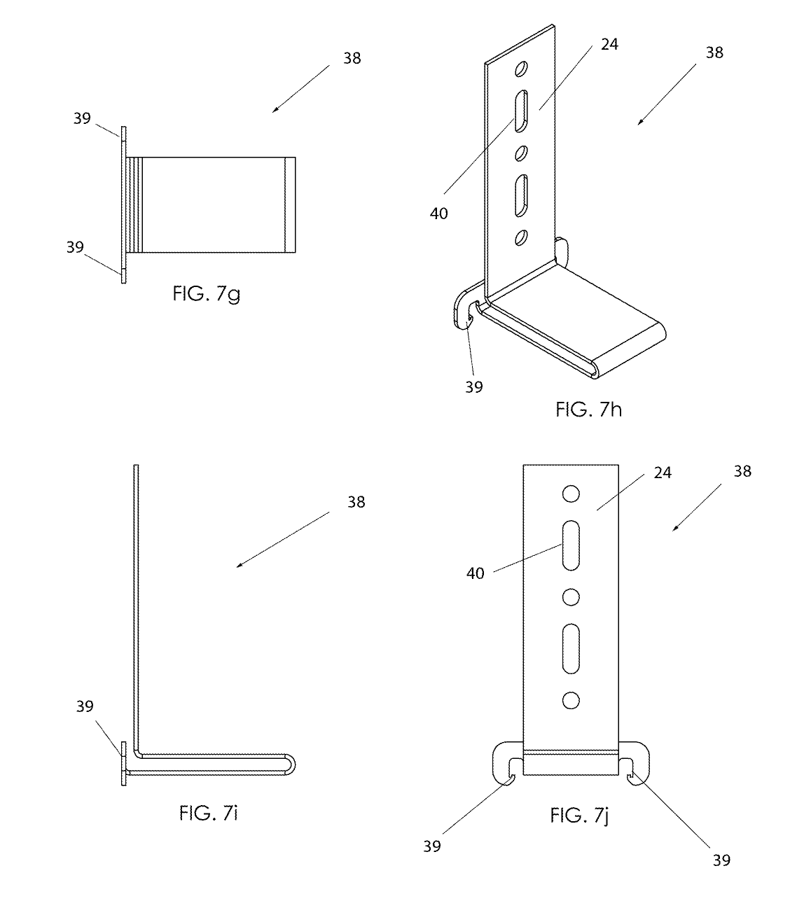

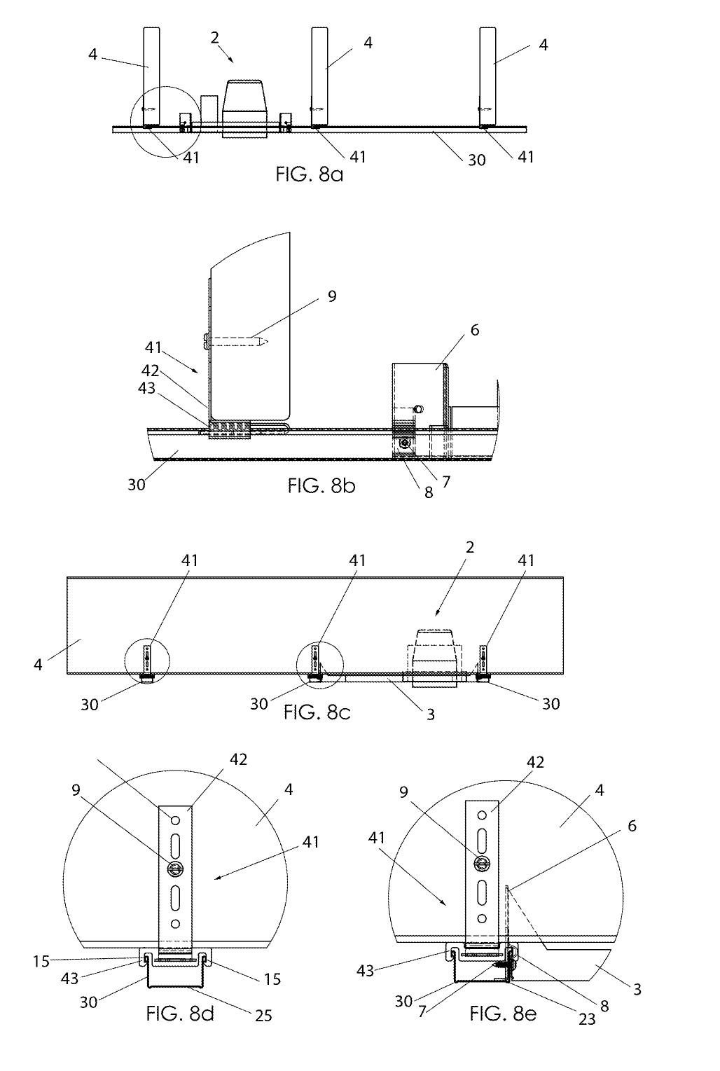

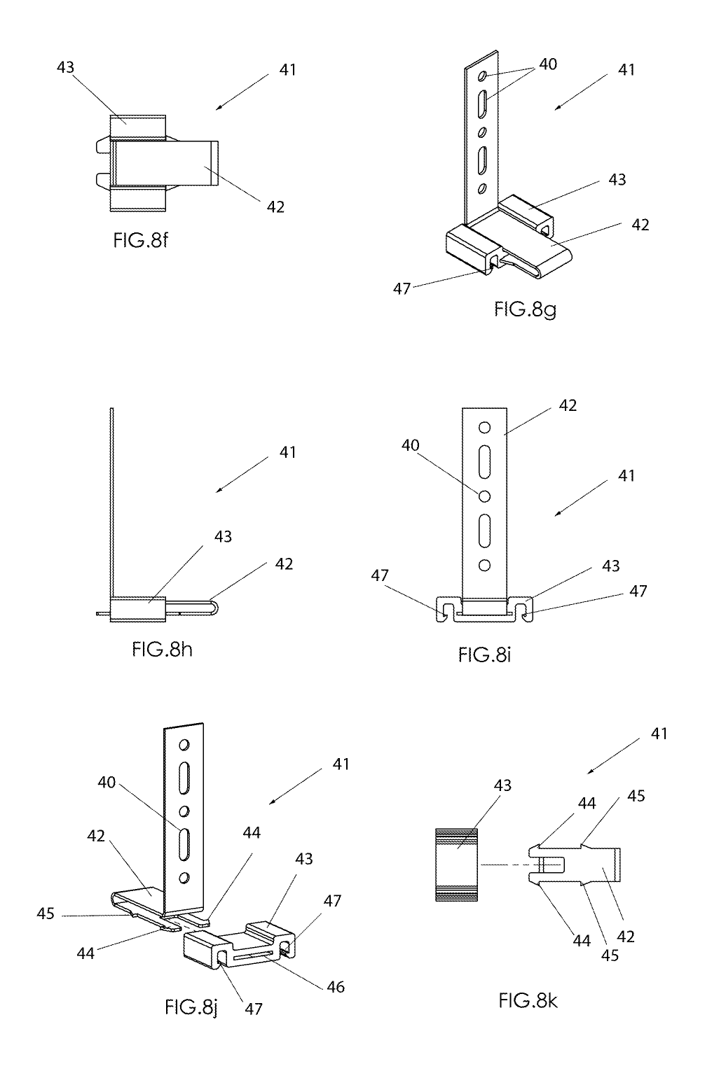

Another alternative installation is illustrated in FIGS. 7a-7f. Resilient hangers 38 are screwed into joists 4 with fasteners 9 through mounting holes 40. The bent sheet metal hanger hooks 39 are hooked beneath hems 15 of support channel 30. A one hundred eighty degree bend in the hanger characterizes a u-shaped cantilever. The geometry of hanger 38 allows it to flex when channel 30 is loaded with drywall, thereby producing a flatter installation with consequent reduction in sound transmission through the structure. Hanger 38, hooks 39, and mounting holes 40 on mounting surface 24, are shown in detail in FIGS. 7g-7j. A variation of this installation is illustrated in FIGS. 8a-8k.

In FIGS. 8a-8e, hanger assemblies 41 are screwed into joists 4 with fasteners 9 through mounting holes 40. The bent sheet metal hanger base 42 and elastomeric retainer 43 retain the hems 15 of channel 30. The cantilever geometry of hanger 38 allows it to flex when channel 30 is loaded with drywall, thereby producing a flatter installation with consequent reduction in sound transmission through the structure. The elastomeric retainer 44 serves as an isolator further reducing the sound transmission through the structure. Pot light 3 is supported by channel 30 via support arms 3. Support arm feet 23 rests on the inside bottom of channel 30. Fastener 7 passes through sprung bent element 8, which extends from flange 6, and threads into channel 30. FIGS. 8f-8k illustrate hanger assembly 41 in further detail. Hanger base 42 includes mounting holes 40, barbed retainers 44, and stops 45 that retain the elastomeric retainer 43 via slot 46. The elastomeric retainer 43 includes hooks 47 on either side that retain hems 15 of channel 30, as can be seen in FIGS. 8a-8e.

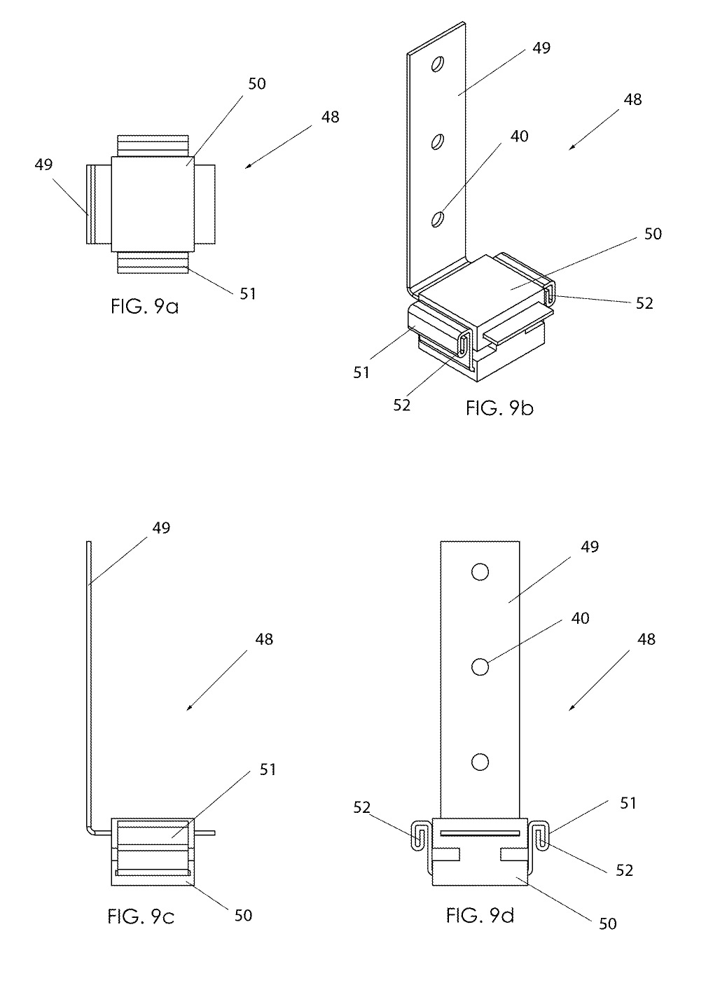

A further variation of flexible hanger assembly is depicted in FIGS. 9a-9e. Hanger assembly 48 includes hanger base 49, isolator 50 and retainer 51. The hanger assembly 48 may be fastened to a joist (not shown) through mounting holes 40. Isolator 50 is made of an elastomeric material held proximate its top by hanger base 49. Isolator 50 supports, proximate its bottom, retainer 51. Retainer 51 includes retainer hems 52, which support hems 15 of channel 30.

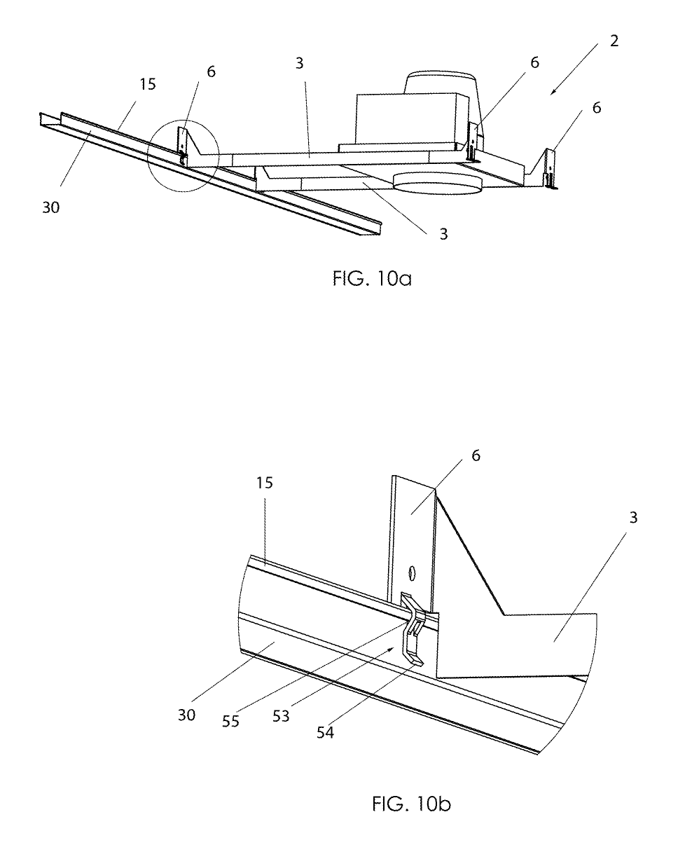

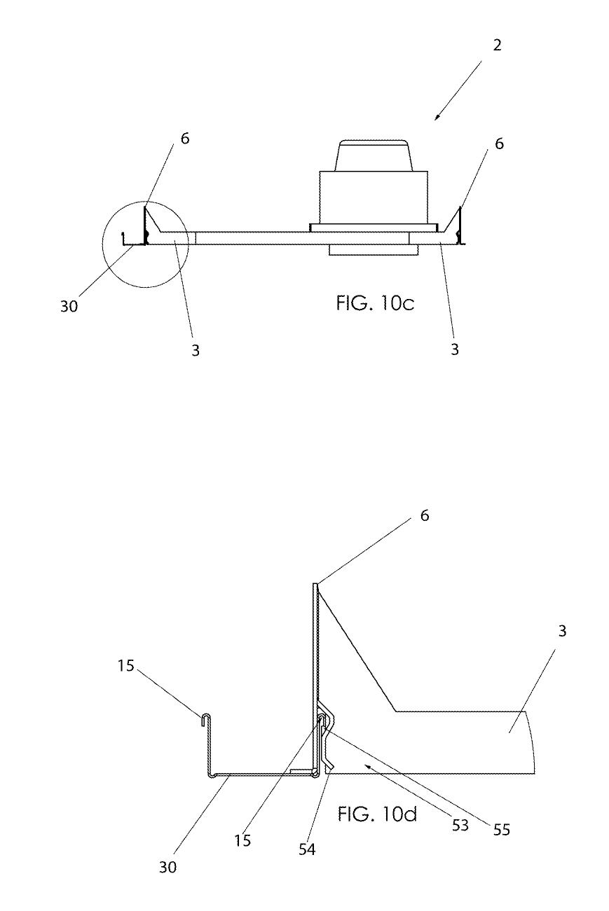

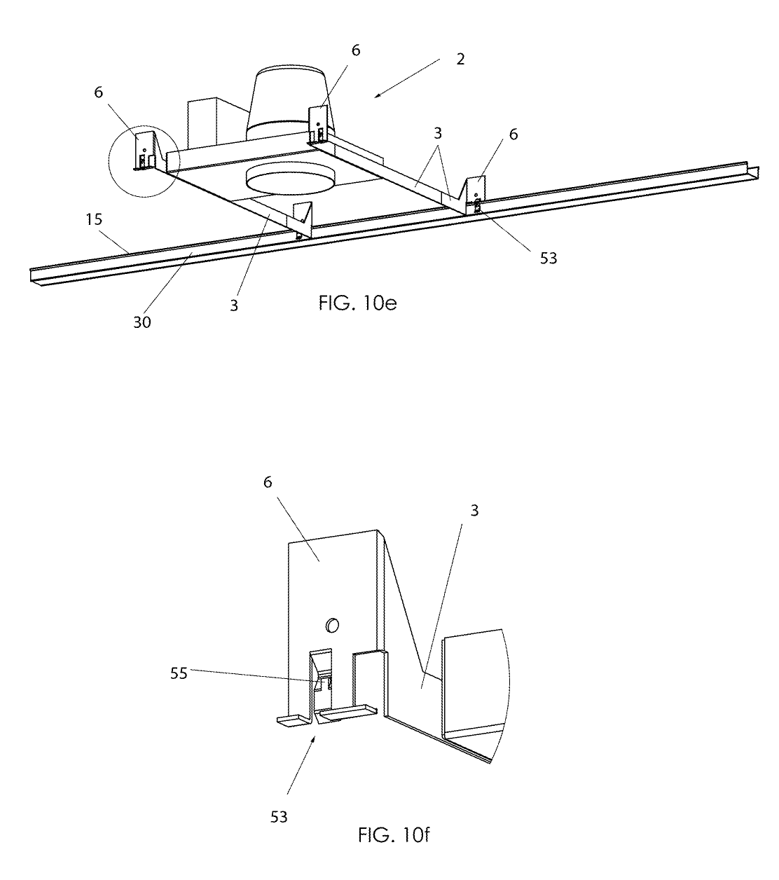

FIGS. 10a-10f exemplify an interface arrangement between support arms 3 of pot light 2 and channel 30. The hanger and joist and the second channel required to support the pot light are not visible. Flange 6, which extends from support arm 3, is formed with a sprung barbed retainer 53 with an upturned leading edge 54 that allows it to extend over hem 15 of channel 30 during installation. Barb 55 locks under hem 15 of channel 30 to secure the support arm 3 and pot light 2 into position without fasteners. Alternative interface arrangements are depicted in FIGS. 11a-13a.

In FIG. 11a, wedge element 56 is fastened via rivet 58 to tab 57 that extends from flange 6. Wedge element 56 is free to rotate about the center of rivet 58. Pot light support arm 3 is hung on hem 15 of channel 30 with wedge element 56 positioned to clear the channel. Once the pot light is positioned, wedge element 56 is rotated until inclined surface 59 rides beneath hem 15 to secure support arm 3 to channel 30. Wedge actuator 60 provides a surface upon which to push and pull with fingers to lock and unlock the wedge element 56.

In FIG. 12a, U-shaped element 61 is seen prior to locking beneath hem 15 of channel 30. U-shaped element 61 is an extension of flange 6 of pot light support arm 3. Slot 62 in U-shaped element 61 runs parallel to channel 30 to create a localized weakness. A bend in U-shaped element 61 allows it to rotate about axis 63 beneath hem 15 of channel 30 to secure pot light support arm 3 in place. A flat head screwdriver or pliers, or the like, can be used to obtain leverage to bend U-shaped element 61 and secure it beneath hem 15.

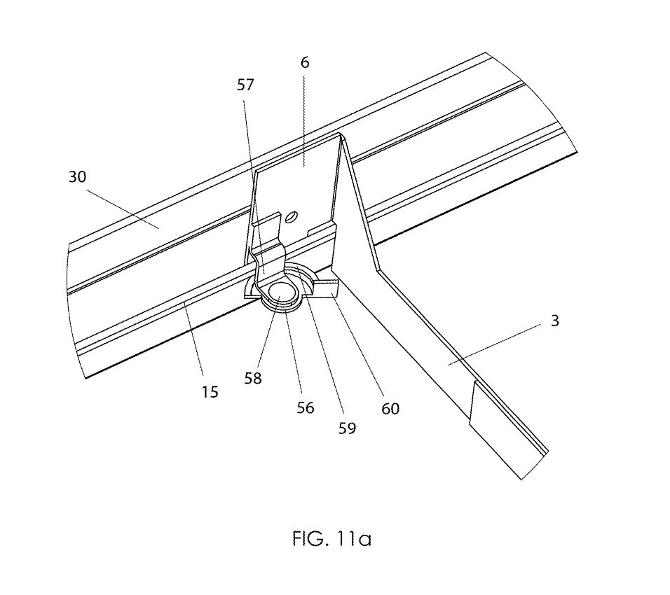

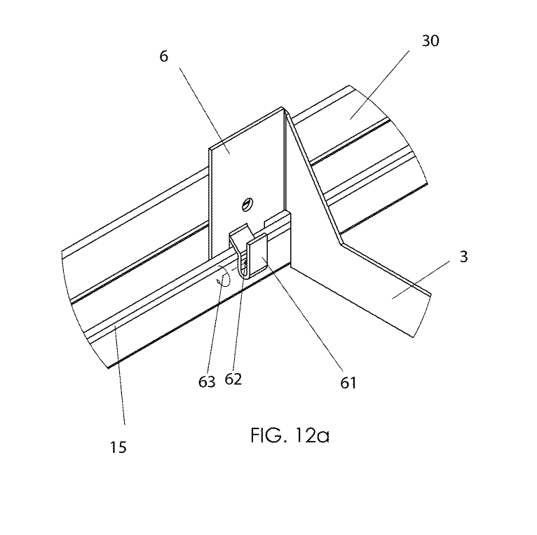

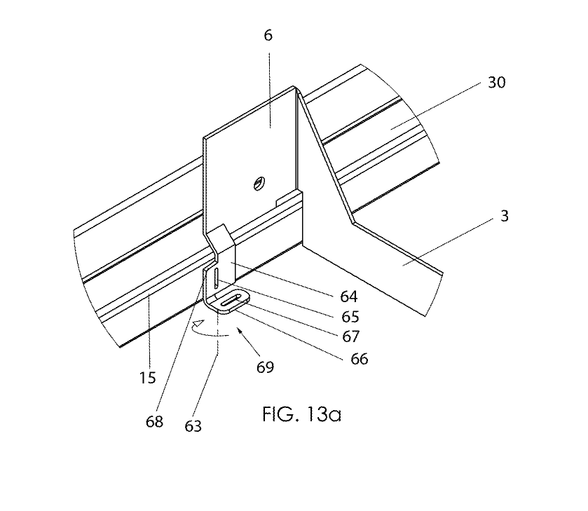

A vertical axis sheet metal locking device 69 can be seen in FIG. 13a. Tab 64 extends from flange 6 of pot light support arm 3. Vertical slot 65 in tab 64 creates a localized weakness. A bend location in tab 64 allows angled edge 68 to rotate about axis 63 and wedge beneath hem 15 of channel 30 to secure pot light support arm 3 in position. Horizontally oriented tab 66 has slot 67 to receive a vertically oriented flat head screw driver or the like from below for the purpose of rotating the locking device 69. Locking device 69 may be made of sheet metal or of a plastic injection molded part with a live hinge that snaps onto flange 6.

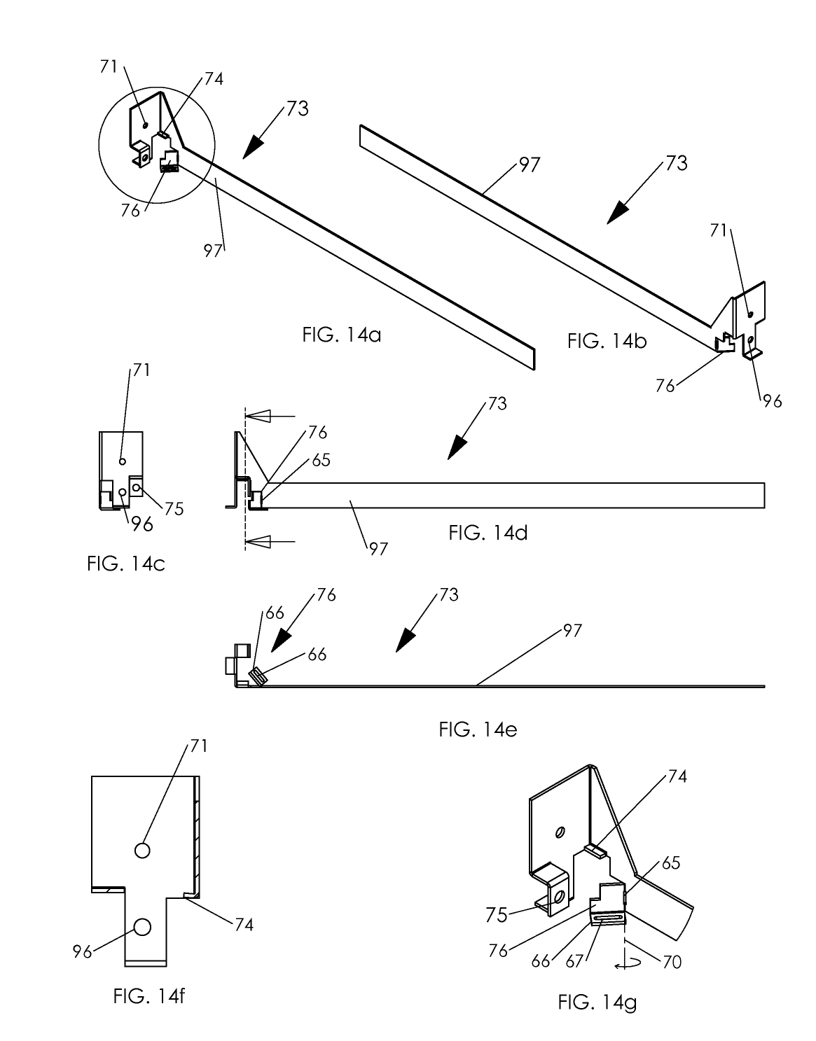

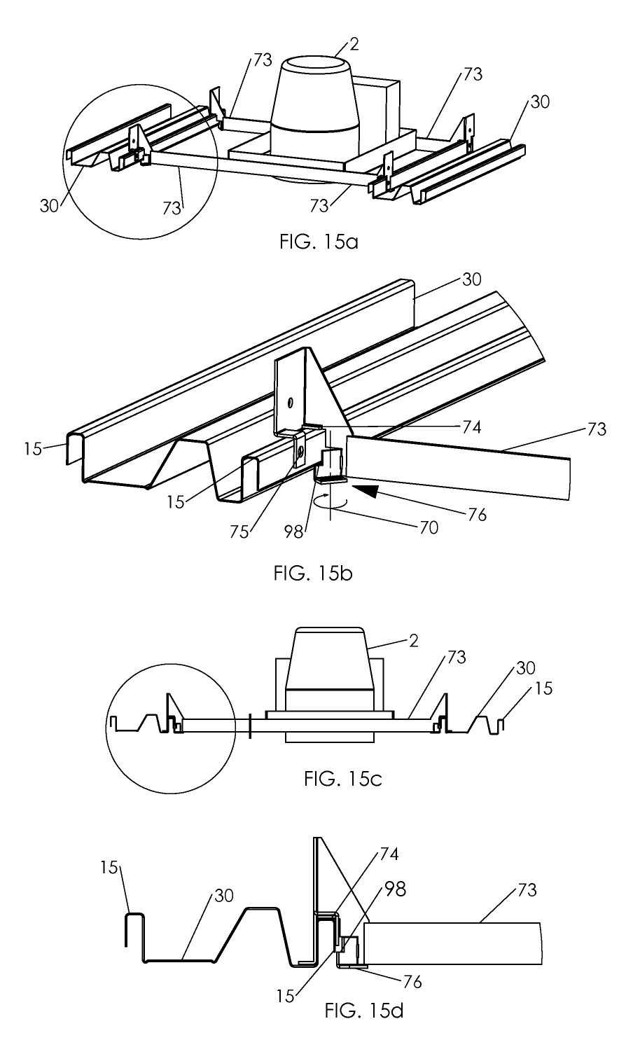

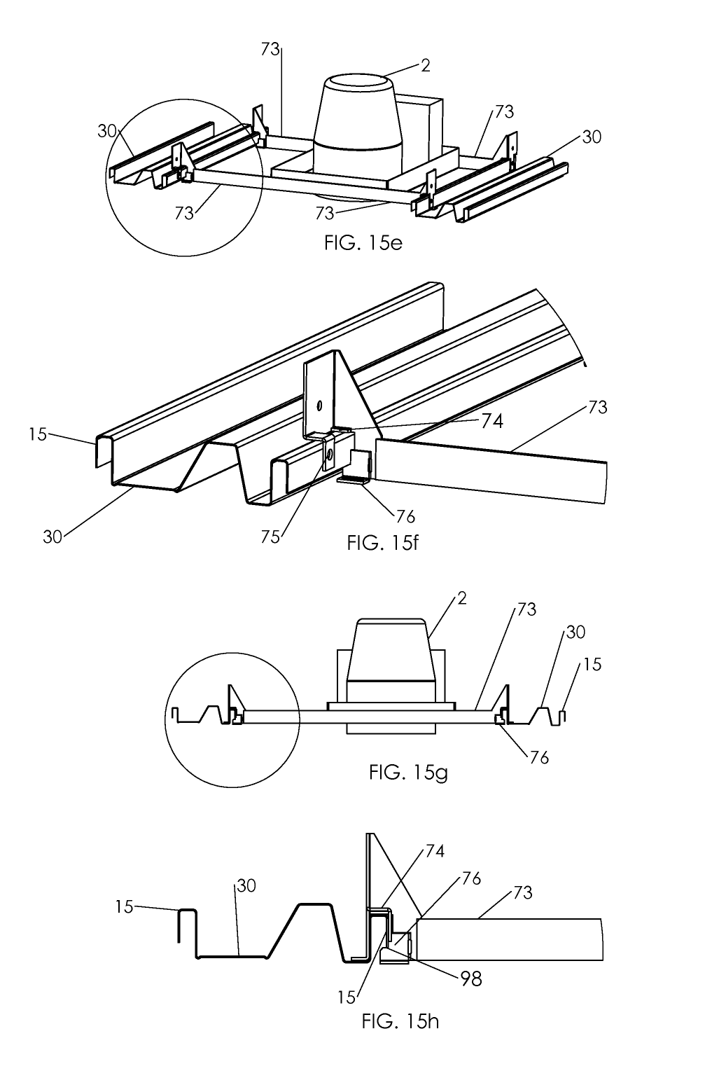

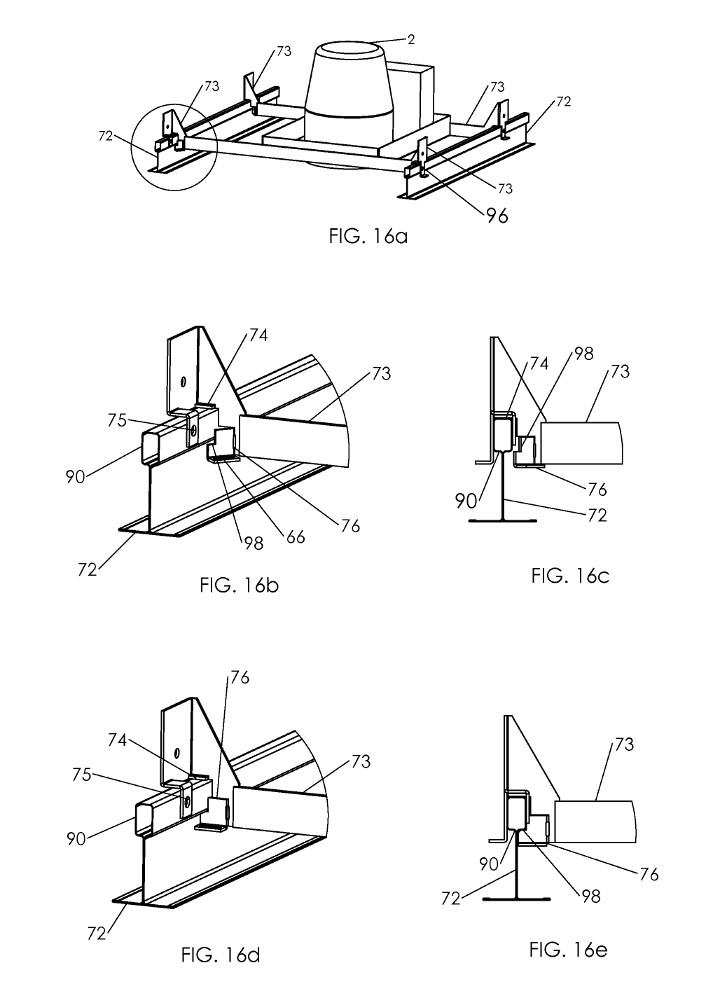

FIGS. 14a-g show an alternative embodiment of twist lock arm 73 similar to the one seen in FIG. 13a. This embodiment has locking device 76 located at the end of vertical arm element 97. Slot 67 on tab 66 can receive a vertically inserted flat head screwdriver to rotate tab 66 and vertical locking element 76 into the locked position. Vertical slot 65 creates a weakened area facilitating hinging about vertical axis 70. Upper hole 71 is used to fasten the arm to a joist using a screw or nail in a conventional manner in the absence of channel or T-bar, if required. The underside of flange 74 acts as a running surface for arm 73 on channel 30, shown in FIGS. 15a-h, and T-bar 72, shown in FIGS. 16a-e. Flange 74 is angled at a range of approximately five degrees above the horizontal to prevent sharp edges from catching and to permit easy sliding of the support arm. Holes 75 and 96 can be used if desired to secure arm 73 to a channel 30, such as shown in FIGS. 15a-h, and T-bar 72, such as shown in FIGS. 16a-e, using a self tapping screw or equivalent means.

FIGS. 15a-d show a pot light assembly 2, such as shown in FIGS. 14a-e, with twist lock arm 73 from FIG. 14a-e hanging on resilient channels 30 by arm 73. The arrangement in the ceiling may be similar to that shown in FIG. 4. Twist lock device 76 is in the unlocked position clear of hem 15. Flange 74 rests on upper horizontal surface of hem 15.

FIGS. 15e-h show pot light assembly 2 of FIGS. 15a-d with twist lock device 76 in the locked position. Locking device 76 is rotated about vertical axis 70 with a flathead screwdriver or the like, so that surface 98 wedges beneath hem 15 of resilient channel 30, thereby holding twist lock arm 73 fixed in place. Lower hole 75 allows fastening with a screw or the like to resilient channel 30 if, for example the locking device 76 is damaged from repeated rotational use.

FIGS. 16a-c show the twist lock pot light assembly 2 from FIGS. 15a-h mounted on T-bar main ceiling element 72 prior to locking. Locking device 76 is clear of rectangular section 90 of T-bar main element 72 allowing the arm to be lowered onto T-bar main element 72. Flange 74 of twist lock arm 73 rests on rectangular section 90 of T-bar ceiling main structural element 72. FIGS. 16d-e show the twist lock arm 73 in the locked position. Locking is achieved in the same manner described for FIGS. 15a-h. Surface 98 on locking device 76 wedges beneath rectangular section 90 holding twist lock arm 73 fixed in place. Lower holes 75 and 96 allow fastening with a screw or the like to T-bar main element 72 from either side, if needed.

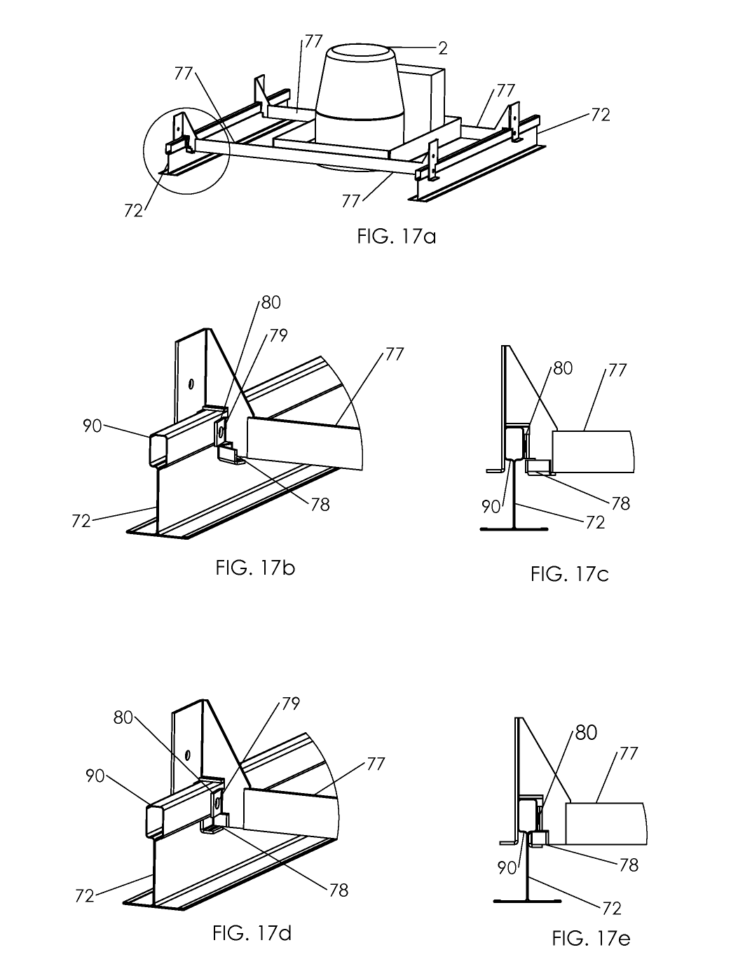

FIGS. 17a-e show an alternative arrangement of twist lock arm 77 on pot light assembly 2, similar to that shown in FIGS. 15a-h and 16a-e. L-shaped twist lock device 78 may be locked into place with a vertically inserted flat head screwdriver. FIGS. 17a-c show twist lock arm 77 prior to locked position, while FIGS. 17d-e show in detail twist lock arm 77 in locked position. Twist lock device 78 holds twist lock arm 77 in place by wedging beneath rectangular section 90 of T-bar main element 72. Tab 80 with, hole 79 located above twist lock device 78, allows fastening with a screw or the like to T-bar main ceiling structural element 72 if needed. Although not shown, locking device 78 can also secure pot light assembly 2 to a channel with a hem similar to the one shown in FIGS. 15a-h.

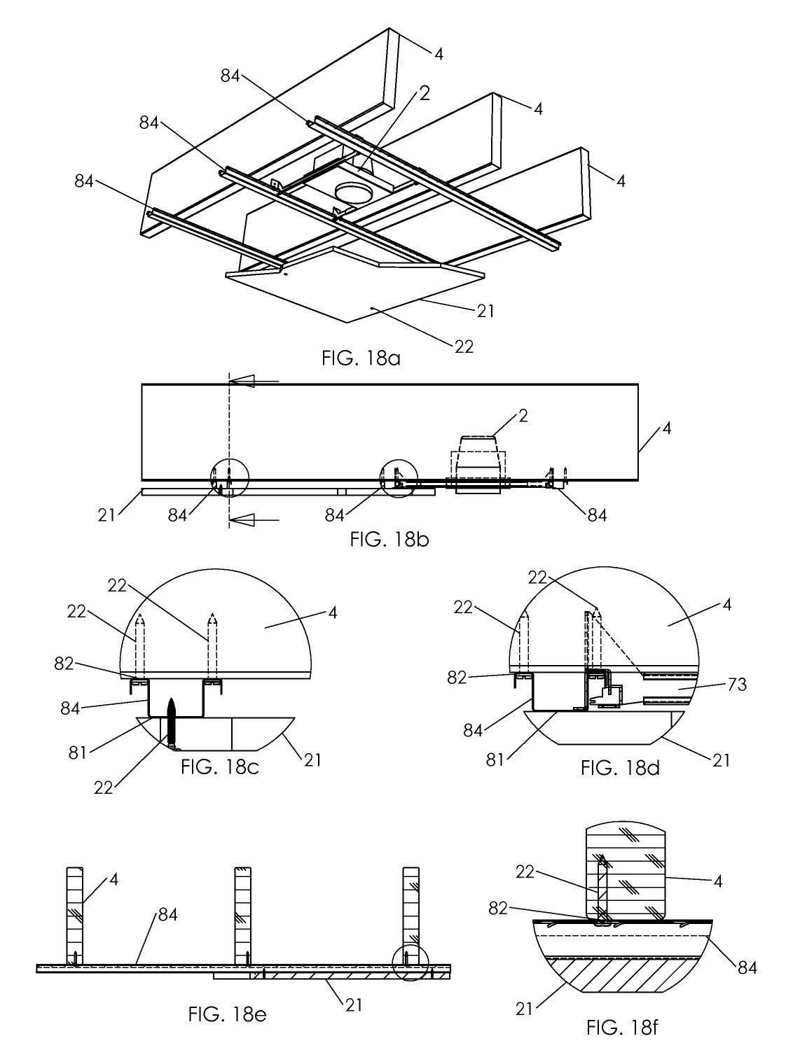

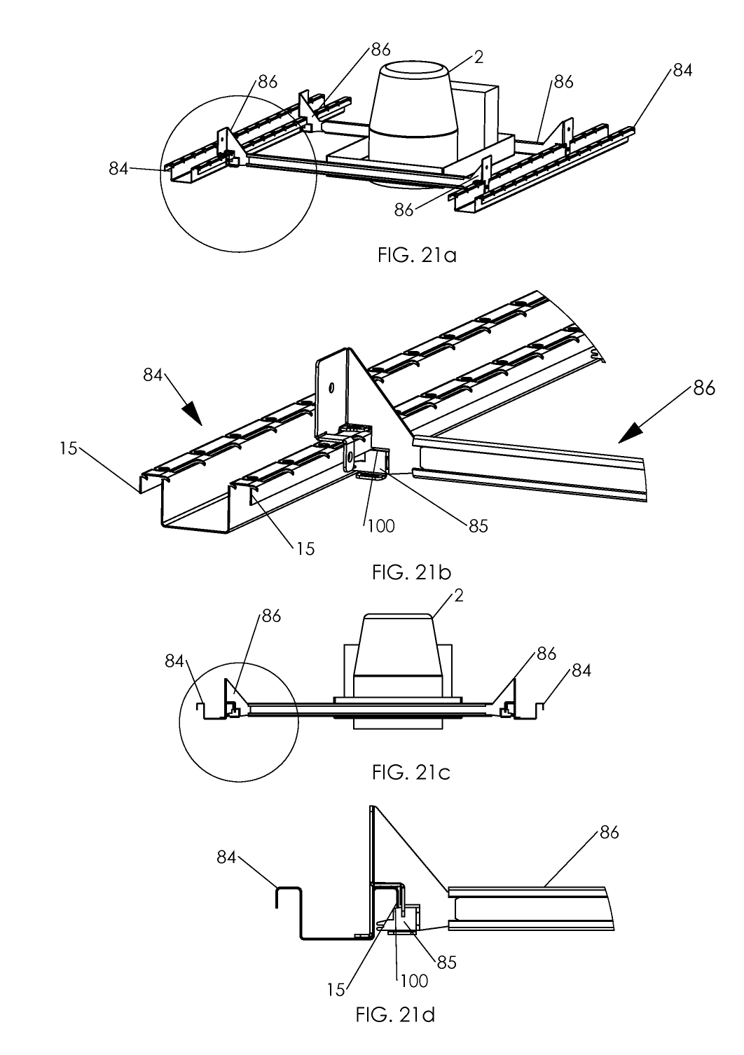

FIGS. 18a-f show pot light assembly 2 mounted on resilient channels 84, an alternate embodiment to the resilient channels 30 shown in FIG. 4a to FIG. 9d. Resilient channels 84 are fixed to the underside of joists 4 with screws 22 through top horizontal flanges 82 of resilient channel 84. Cut away drywall 21 is installed horizontally with fasteners 22 from beneath into central horizontal flange 81 of resilient channels 84. FIGS. 21a-d shows in detail the mounting of pot light assembly 2 to resilient channel 84.

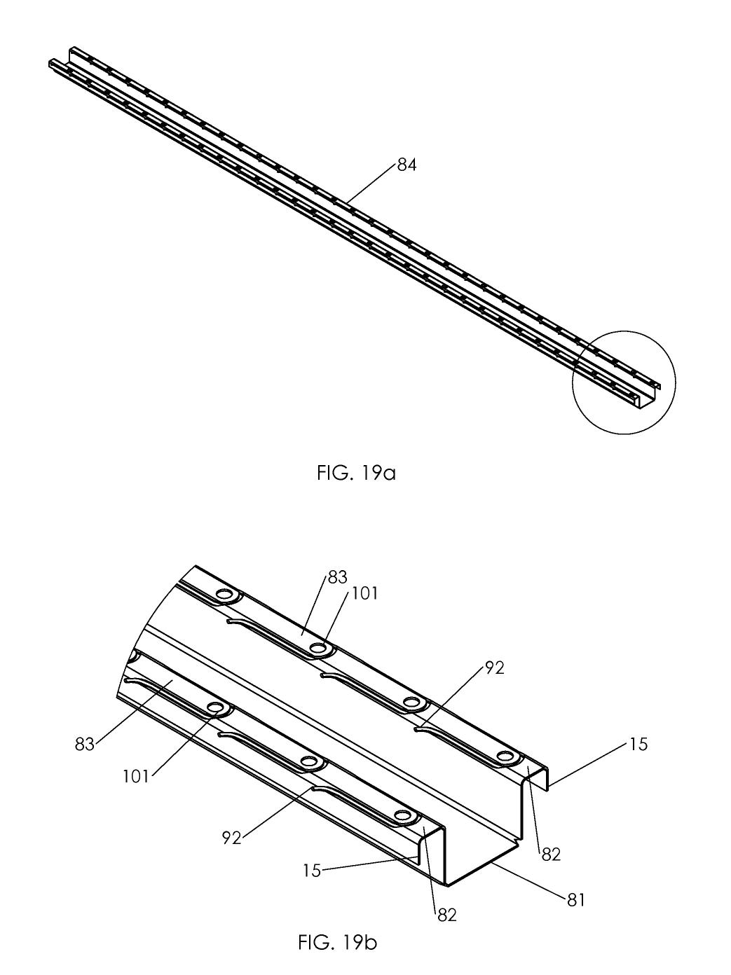

FIGS. 19a-b illustrates a length of resilient channel 84, shown in FIGS. 18a-f. Sprung tabs 83 with screw mounting holes 101 are located on top horizontal flanges 82. Stress relief cutouts 92 limit the stress at the base of tab 83. Resilient channel 84, for example, may be fabricated in sheet metal, punching tabs 83 and holes 82, and roll forming

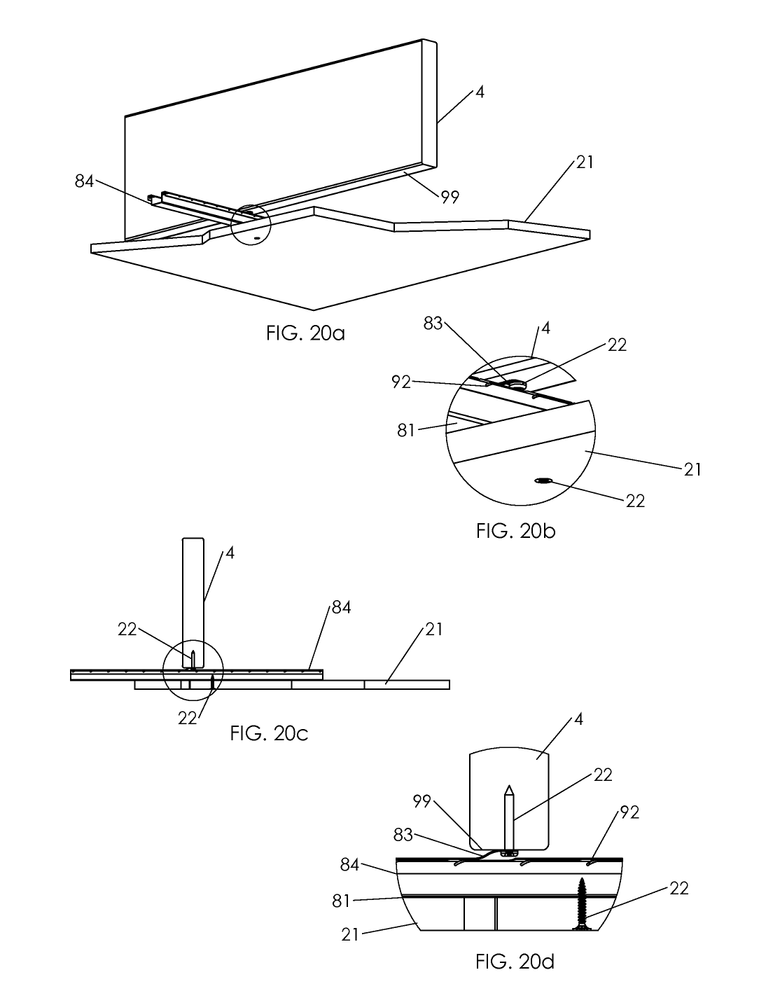

FIGS. 20a-d illustrates resilient channel 84 from FIGS. 19a-b mounted with fasteners 22 on joist 4 supporting substrate 21. Substrate 21 is mounted horizontally with fastener 22 to the underside of channel 84 through central horizontal flange 81. The weight of drywall 21 and the non-planar surface 99 of adjacent joists 4, not shown, cause sprung tabs 83 to deflect as required, thereby providing a flatter drywall installation. Sprung tabs 83 decouple drywall 21 from joists 4, thus dampening vibration and reducing sound transmission between floors.

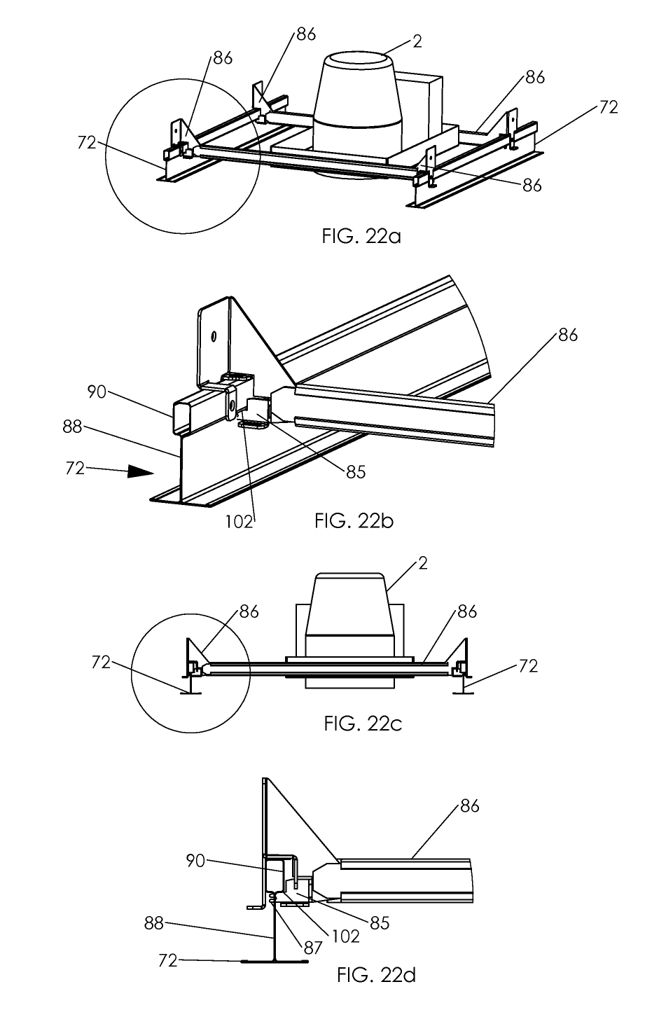

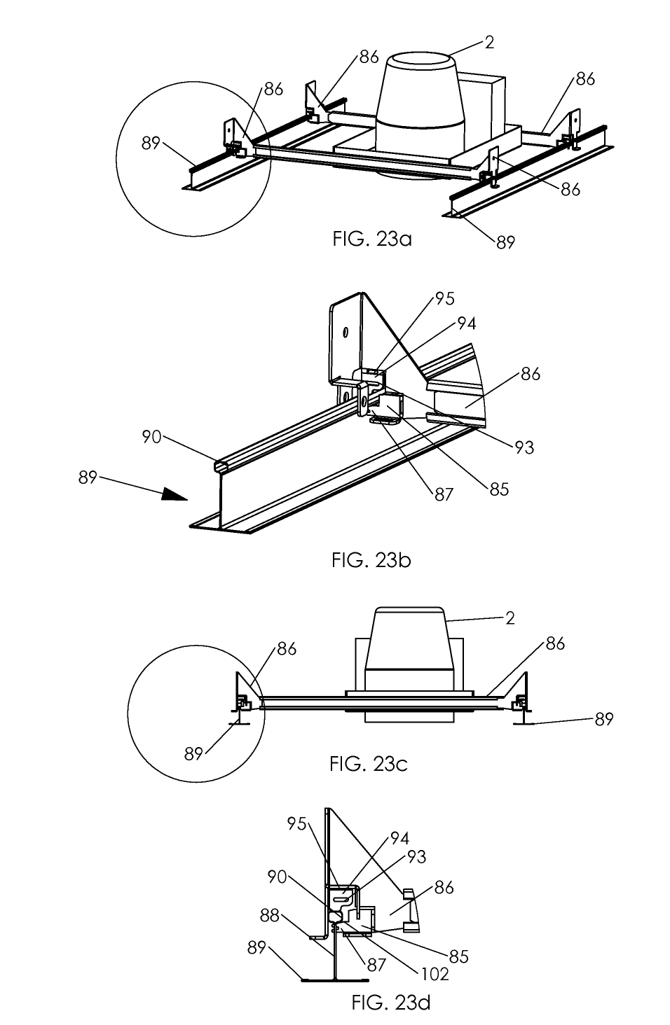

FIGS. 21a-d show a perspective view of the pot light 2 with support arms 86 mounted on resilient channel 84 with sprung tabs 83. This embodiment of support arm 86 is similar to twist lock arm 73 shown in FIGS. 14a-g. However, the support arm is capable of being mounted on resilient channels 30 and 84 as well as T-bar main structural elements 72, shown in FIGS. 22a-d, and T-bar cross structural elements 87, shown in FIGS. 23a-d. Upper surface 100 of the locking device 85 wedges beneath outside vertical flange 15 of resilient channel 84.

FIGS. 22a-d show pot light 2 with support arms 86 mounting on T-bar main structural elements 72 similar to the embodiment shown in FIGS. 16a-e. Surface 102 of the locking tab 85 wedges below rectangular section 90 of main structural element 72, securing twist lock arm 86 in place. Additional retention is accomplished with teeth 87 underneath the rectangular section 90 of the T-bar main structural element 72. Although teeth 87 at the end of the locking tab 85 appear to pierce through vertical section 88, they are designed to deform as they contact vertical section 88 of T-bar cross structural element 72 to provide additional retention to locking device 85.

FIGS. 23a-d show the pot light assembly 2 with support arm 86 on T-bar cross structural elements 89. To accommodate the smaller height of rectangular structural element 89, tab 94 is bent along oblong hole 95 from the horizontal position required for mounting on channel, shown in FIGS. 20a-d, and T-bar main elements, shown in FIGS. 21a-d, to a vertical position using a flat head screwdriver or the like in slot 93. The end of the tab 94 rests on the top of the structural element 89, supporting arm 86. Locking device 85 to structural element 89 is accomplished in the same manner as with T-bar main structural elements 72, as seen in FIG. 22a-d, by vertically rotating locking tab 85 wedging surface 102 beneath the rectangular top section 90 of cross element 89. Although teeth 87 at the end of the locking device 85 appear to pierce through vertical section 88, they are designed to deform as they contact vertical section 88 of T-bar cross structural element 89 to provide additional retention to locking device 85.

In this disclosure there are shown and described only exemplary embodiments of the invention and but a few examples of its versatility. It is to be understood that the invention is capable of use in various other combinations and environments and is capable of changes or modifications within the scope of the inventive concept as expressed herein. For example, the present disclosure has applicability for supporting various other ceiling fixtures, separately or in addition to pot lights, such as speakers, camera mechanisms, and like electrical devices. The size of the disclosed brackets may be made smaller or larger in accordance with joist spacing. In addition, the disclosed resilient channel embodiments can also be applied to walls to allow drywall to be flatter and sound transmission to be reduced across the wall. The term “drywall” as it appears throughout the disclosure should be understood to represent any appropriate substrate that can be used for enclosing building structure.

What is claimed is:

1. Apparatus comprising:
a ceiling fixture support arm; and
a rotational mechanism configured to interface the arm with ceiling support system structure;
wherein the rotational mechanism is integral with the fixture support arm.

2. Apparatus as recited in claim 1, wherein:
the support arm comprises a first member having a distal end extending from the ceiling fixture, and a second member generally perpendicular to the first member and joined to the end of the first member; wherein
the rotational mechanism comprises a hinged portion of one of the first and second members.

3. Apparatus as recited in claim 2, wherein the first and second members comprise sheet metal material.

4. Apparatus as recited in claim 3, wherein
the hinged portion comprises a fold line in the sheet metal defining a rotational axis;
and further comprising an aperture in the hinged portion proximate the fold line.

5. Apparatus as recited in claim 4, wherein the fold line comprises a weakened area in the sheet metal.

6. Apparatus as recited in claim 2, wherein the hinged portion is formed on the first member for locking the support arm to the ceiling system support structure.

7. Apparatus as recited in claim 6, wherein the ceiling support system comprises a channel affixed to a ceiling joist, and the support arm is configured for locking to the channel.

8. Apparatus as recited in claim 6, wherein the second member further comprises means for securing the support arm to the channel.

9. Apparatus as recited in claim 2, wherein the hinged portion is formed on the second member to adjust a height dimension of the support arm relative to the ceiling support system.

10. Apparatus as recited in claim 2, wherein the first and second members comprise plastic material.

11. Apparatus as recited in claim 10, wherein the hinged portion comprises a weakened fold line in the plastic material.

12. Apparatus as recited in claim 2, wherein the ceiling support system comprises a resilient channel, and the support arm further comprises a flange having a surface for sliding the support arm on the resilient channel.

13. Apparatus comprising:
a ceiling fixture support arm configured to interface with a ceiling support system T-bar, the support arm comprising:
a first rotational mechanism having a rotational axis within the support arm; and
a second rotational mechanism having a second rotational axis within the support arm.

14. Apparatus as recited in claim 13, wherein the rotational axis of the first rotational mechanism is generally orthogonal to the rotational axis of the second rotational mechanism.

15. Apparatus as recited in claim 13, wherein each rotational mechanism comprises a hinged tab in a respective portion of the support arm.

16. Apparatus as recited in claim 15, wherein the axis of the first rotational mechanism is aligned generally vertically with respect to a height dimension of a T-bar, wherein the first rotational mechanism is operative to lock the support arm to the T-bar.

17. Apparatus as recited in claim 16, wherein the axis of the second rotational mechanism is aligned generally horizontally with respect to the height dimension of a T-bar;
wherein the second rotational mechanism is operative to adjust the tab thereof to first and second positions to adjust the interface height of the support arm corresponding to T-bars of different heights.

18. Apparatus as recited in claim 16, wherein the first tab position is generally horizontal to accommodate a main T-bar, and the second tab position is generally vertical to accommodate a cross T-bar, the cross T-bar height less than the height of the main T-bar.

19. Apparatus as recited in claim 15, wherein each hinged tab comprises:
a weakened fold line in the support arm material; and
an aperture in the tab proximate the fold line.

20. A ceiling support system comprising:
a resilient channel having a length corresponding to the distance between a plurality of ceiling joists, the channel comprising:
first and second flanges extending along the length of the channel, the first and second flanges separated from each by a channel width;
wherein each flange comprises a plurality of flexible sections spaced at intervals along the channel length.

21. A ceiling support system as recited in claim 20, wherein each section comprises a cantilevered tab formed in the flange material.

22. A ceiling support system as recited in claim 21, wherein an end of the tab is integral with the flange material and the remainder of the tab is detached from the flange material.

23. A ceiling support system as recited in claim 22, wherein each portion comprises a mounting hole proximate its detachable end, configured for mounting the flange to a ceiling joist.

24. A ceiling support system as recited in claim 23, wherein the section interval spacing corresponds to coincidence between tab mounting holes and adjacent ceiling joists.

25. A ceiling support system as recited in claim 23, wherein a flexibility characteristic of the tabs permit separation of mounted flanges from the joists.

26. A ceiling support system as recited in claim 25, comprising curved portions at the integral end of the tab to prevent detachment of the tab from the flange.

27. A ceiling support system as recited in claim 25, wherein the distance between the integral end of the tab and the mounting hole is set to correspond to a selected degree of separation between the flange and the joist.

28. A ceiling support system as recited in claim 25, wherein the channel is comprised of sheet metal, the metal channel isolated from wood joists except for attachment of detached ends of the cantilevered portions, thereby providing a sound proofing effect between adjacent building floor levels.
